(19) United States
(12) Patent Application Publication
(10) Pub. No.: US 2010/0048327 A1
(43) Pub. Date: Feb. 25, 2010

(54) Highly-Neutralized Golf Ball Compositions

(76) Inventors: David A. Bulpett, Boston, MA (US); Nathan Zieske, Mattapoisett, MA (US); Brian Comeau, Berkley, MA (US)

Correspondence Address: ACUSHNET COMPANY, 333 BRIDGE STREET, P. O. BOX 965, FAIRHAVEN, MA, 02719, US

(21) Appl. No.: 12/194,227

(22) Filed: Aug. 19, 2008

(51) Int. Cl. A63B 37/00; C08L 33/02; C08K 5/52; C08K 5/04; C08K 5/09

(52) U.S. Cl. 473/374; 524/556; 524/147; 524/280; 524/300

(57) ABSTRACT

The present invention is directed to a golf ball and to a process for forming a golf ball having at least one layer, where the layer is formed of a highly neutralized polymer composition having greater than about 70 percent of the acid groups neutralized by a neutralizing agent including ammonium salts, monoamine salts, inner salts, chelates and their ligands, surfactants, phospholipids, ionic liquids, long-chain organic carbonates, main-chain heteroatom-substituted fatty acids, or a combination thereof.

### FIELD OF THE INVENTION

The present invention relates to highly neutralized compositions for golf balls that include a polymer component including an acid copolymer, partially neutralized polymer, or combination thereof, that is neutralized to at least about 70 percent with a plasticizer or a plasticizer blend.

### BACKGROUND OF THE INVENTION

Golf ball manufacturers have been using ionomer resins for golf ball component materials because of their durability, rebound, and scuff resistance characteristics. Ionomer resins are generally understood as thermoplastic polymers that are ionically crosslinked, and which may contain both hydrogen and ionic bonds. Ionomers are typically derived from copolymers of an olefin, e.g., ethylene, and an α,β-unsaturated carboxylic acid, e.g., acrylic acid, methacrylic acid, or maleic acid, that are partially neutralized with metal ions such as sodium, lithium, zinc, or magnesium ions, as disclosed in U.S. Pat. Nos. 3,264,272 and 3,404,134. Examples of commercially available ionomer resins include, but are not limited to, SURLYN® from DuPont de Nemours and Company, and ESCOR® and IOTEK® from Exxon Corporation. These ionomer resins are distinguished by the type of metal ion, the amount of acid, and the degree of neutralization.

Those of ordinary skill in the art are aware that increasing the neutralization of ethylene-based ionomers during manufacturing reduces the processability of the material. This is demonstrated by the decreased melt flow index of the resulting material, which can be measured according to ASTM method D-1238, procedure A using a 2.16 kg weight. In fact, in some cases, the melt flow index of the material is decreased to the point that the material does not flow at all under normal processing conditions. Once the neutralization is greater than about 60 percent, depending upon the cation(s) present, the melt flow of the ionomer is too low to easily process the material. And, in some cases, e.g. trivalent cations, the threshold percent for non-processability of the material is much lower than about 60 percent. As a result, commercially available ethylene-based ionomers are generally only partially neutralized.

And, while certain highly neutralized polymers have recently been discussed in U.S. Pat. No. 6,329,458, U.S. Patent Publication Nos. 2001/0019971 and 2001/0018375, and International Publication No. WO 01/29129, these polymers are produced using organic fatty acid salts. Potential compatibility issues remain with these fatty acid-based highly neutralized polymers, however, due to their hydrophobic backbone moiety. In addition, the fatty acids may, depending on molecular weight and/or boiling point, vaporize during injection molding, generating a large amount of gas, which may lead to molding defects. The presence of this gas may also result in gas constituents settling on the surface of the molded object, which greatly lowers the adhesiveness of the object to paint or additional layers.

In addition, the recent trend toward light stable cover materials has introduced durability and adhesion issues, particularly between an ionomer resin inner cover layer and a polyurethane outer cover layer. For example, the inner components of most commercially available polyurethane covered or layered golf balls undergo a surface treatment, e.g., corona discharge or silane dipping, to overcome the adhesion problems. The surface treatment, however, adds cost and time to the manufacturing process.

Thus, a need exists in the golf ball art for a resin material that is easily processed with desirable melt flow and molding characteristics. In addition, a need exists for improved cover layer materials that reduce or eliminate adhesion problems with other cover layer materials. Moreover, a need exists in the art for a method to mold this material into highly durable, resilient golf balls that allow the manufacturer to tailor the ball to have virtually any combination of feel and spin rate.

### SUMMARY OF THE INVENTION

The present invention is directed to a golf ball including at least one layer formed of a reaction product comprising a thermoplastic resin component having a first amount of neutralized acid groups; and a plasticizing agent, such as an inner salt, a chelate, a surfactant, a phospholipid, an ionic liquid, a long-chain organic carbonate, a main-chain heteroatom-substituted fatty acid, and mixtures thereof, wherein the reaction product has a second amount of neutralized acid groups greater than the first, and wherein the second amount is 70 percent or greater, preferably 80 percent or greater, more preferably 90 percent or greater.

In one embodiment, the thermoplastic resin component is a copolymer of ethylene and acrylic acid or methacrylic acid. In another embodiment, the reaction product includes a neutralizing agent, such as ammonium-based compounds and salts thereof, amine-based compounds and salts thereof, and mixtures thereof.

The present invention is also directed to a golf ball including a core, a cover; and an intermediate layer disposed between the core and the cover, wherein the intermediate layer includes a thermoplastic resin having acid groups; and a neutralizing agent, such as an inner salt, a chelate, a surfactant, a phospholipid, an ionic liquid, a long-chain organic carbonate, a main-chain heteroatom-substituted fatty acid, and mixtures thereof, wherein the acid groups are at least about 70% neutralized, preferably 80%, more preferably 90%, and most preferably 100% neutralized.

In one embodiment, the intermediate layer has a hardness of about 30 Shore D to about 70 Shore D. The cover may include a castable polyurethane, a polyurea, or a mixture thereof. The thermoplastic resin ispref a copolymer of ethylene and acrylic acid or methacrylic acid.

The present invention is further directed to a golf ball including at least one layer formed of a reaction product comprising a thermoplastic resin component comprising acid groups, wherein the thermoplastic resin component is a copolymer of ethylene and acrylic acid or methacrylic acid; and a plasticizing agent, such as an inner salt, a chelate, a surfactant, a phospholipid, an ionic liquid, a long-chain organic carbonate, a main-chain heteroatom-substituted fatty acid, and mixtures thereof, wherein the acid groups are at least about 70% neutralized.

In one embodiment, less than 70% of the acid groups are neutralized with a metal cation and the balance being neutralized by the plasticizing agent. Preferably 30% or greater of the neutralized acid groups are neutralized by the plasticizing agent, more preferably 50% or greater, and most preferably 80% or greater.

### BRIEF DESCRIPTION OF THE DRAWINGS

FIG. 1 is a cross-sectional view of a two layer ball, wherein at least a portion of the golf ball is formed from the compositions of the invention;

FIG. 2 is a cross-sectional view of a multi-component golf ball, wherein at least a portion of the golf ball is formed from the compositions of the invention; and

FIG. 3 is a cross-sectional view of a multi-component golf ball including a core, an outer core layer, a thin inner cover layer, and a thin outer cover layer disposed thereon, wherein at least a portion of the golf ball is formed from the compositions of the invention.

### DETAILED DESCRIPTION OF THE INVENTION

The present invention is directed to highly neutralized polymer compositions for forming one or more layers of a golf ball. Unlike conventional polymers, the compositions pf the invention may be compositions where the acid groups have been neutralized to a high degree, i.e., about 70 percent or greater. The neutralization may occur in several ways:

1) an acid copolymer is neutralized with a neutralizing component of the invention;

2) a partially neutralized polymer is further neutralized with a neutralizing component of the invention;

3) a blend of an acid copolymer and a partially neutralized polymer is neutralized with a neutralizing component of the invention;

4) an acid copolymer is neutralized with a plasticizer of the invention;

5) a partially neutralized polymer is further neutralized with a plasticizer of the invention; and

6) a blend of an acid copolymer and a partially neutralized polymer is neutralized with a plasticizer of the invention.

In addition, any of the above six categories can be combined to form a highly neutralized or fully neutralized polymer composition of the invention. For example, an acid copolymer that is neutralized with a neutralizing component of the invention may be further neutralized with a plasticizer of the invention to form a highly neutralized or fully neutralized polymer composition.

The degree to which the polymer compositions of the invention are neutralized may vary. For example, on a continuum of neutralization, a partially neutralized polymer of the present invention is neutralized to a lesser degree than a highly neutralized polymer, and a highly neutralized polymer is neutralized to a lesser degree than a fully neutralized polymer. As used herein, the term highly neutralized polymer is intended to cover those polymers having greater than about 70 percent of the acid groups neutralized. In one embodiment, about 80 percent or greater of the acid groups are neutralized. In another embodiment, about 90 percent or greater of the acid groups are neutralized. In still another embodiment, all of the acid groups (100 percent) in the polymer composition are neutralized, i.e., the composition is “fully neutralized”. As such, for the purposes of this invention, “highly neutralized polymer,” by definition, also includes “fully neutralized polymers,” however, the term “fully neutralized polymer” does not include polymers that have unneutralized acid groups.

Neutralization according to the present invention produces compositions that are easily melt processable and are believed to have good adhesion characteristics, as well as better compatibility and resiliency. Because of these benefits, the compositions of the invention are adaptable to most molding methods and, as such, are useful in any layer of a golf ball. For example, the neutralized compositions of the present invention may be useful in golf ball intermediate layers and outer cover layers, as well the innermost components of golf balls, such as core layers.

In addition, the highly neutralized ionomer compositions may reduce or eliminate the adhesion problems typically encountered when using an ionomeric material in one layer and a light stable material in a surrounding layer. As such, the compositions of the invention may be useful as an intermediate layer or inner cover layer with a light stable polyurethane or polyurea cover disposed thereon.

As discussed above, one method of obtaining a highly or fully neutralized polymer composition of the present invention is to use a neutralizing component with an acid copolymer, partially neutralized polymer, or a mixture thereof. Suitable neutralizing components of the invention include, but are not limited to, ammonium-based components, salts of ammonium-based components, amine-based components, salts of amine-based components, and mixtures thereof.

For example, a highly neutralized composition of the invention may be formed by adding primary, secondary, or tertiary ammonium-based compounds (or derivatives thereof) to an acid copolymer, partially neutralized ionomer, or a mixture thereof, where the ammonium-based compound has one of the following general formulae:

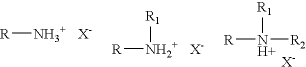

where R, R₁, and R₂ may be hydrogen, any linear or branched alkyl group having from about 1 to about 50 carbon atoms, preferably about 1 to about 30 carbon atoms, or from about 1 to about 12 carbon atoms, aryl group, phenyl group, a cyclic group, or mixture thereof, and X⁻ is selected from halide, hydroxide, carboxylate, and other suitable anionic moieties. The organic groups R, R₁, and R₂ may be the same or different from each other.

A generic reaction scheme for neutralization of an acid copolymer with an ammonium-based component according to the present invention is as follows:

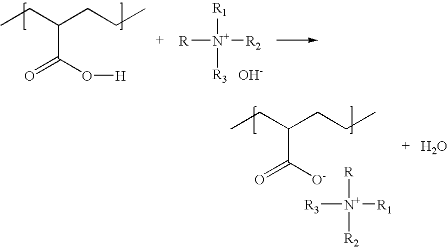

where R, R₁, R₂, and R₃ may be hydrogen, any linear or branched alkyl group having from about 1 to about 50 carbon atoms, preferably about 1 to about 20 carbon atoms, or from about 1 to about 12 carbon atoms, aryl group, phenyl group, a cyclic group, or mixture thereof. The organic groups R, R₁, R₂, and R₃ may be the same or different from each other.

In addition, the highly neutralized or fully neutralized polymer compositions of the invention may be formed by adding monoammonium salt (or derivative thereof) or diammonium salt, i.e., containing R₃NH⁺, to an acid copolymer, partially neutralized ionomer, or mixture thereof. One example of an ammonium salt is a quaternary ammonium salt having the following general formula:

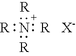

where R is any alkyl group, and wherein X⁻ may be any one of fluoride, chloride, bromide, iodide, hydroxide, carbonate, other suitable anionic moiety or mixtures thereof. Examples of alkyl groups include lower alkyl, for example, methyl, ethyl, n-propyl, iso-propyl, n-butyl, iso-butyl or tert-butyl; upper alkyl, for example, octyl, nonyl, decyl, and the like; and lower alkylene, for example, ethylene, propylene, butylene, pentene, hexene, heptene, octene, norbornene, nonene, decene and the like. In addition, such alkyl groups may also contain various substituents in which one or more hydrogen atoms has been replaced by a functional group. Functional groups include, but are not limited to, hydroxyl, amino, carboxyl, sulfonic amide, ester, ether, phosphate, thiol, nitro, silyl, and halogen (fluorine, chlorine, bromine and iodine).

The synthesis of quaternary ammonium salt should be known to those of ordinary skill in the art. For example, an amine can react with an alkyl halide, producing an amine of the next higher class, wherein one of the hydrogens attached to nitrogen has been replaced by an alkyl group, which eventually produces an ammonium salt. The general reaction scheme is:

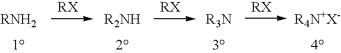

In one embodiment, the quaternary ammonium salt is a tetraalkyl ammonium hydroxide, which has the following general formula:

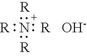

where R is any alkyl or aryl group. Non-limiting examples of quaternary ammonium hydroxides include tetraalkylammonium hydroxides such as tetramethylammonium hydroxide, tetraethylammonium hydroxide, tetra-n-propylammonium hydroxide, tetra-n-butylammonium hydroxide, tetra-n-hexylammonium hydroxide, tetra-n-octylammonium hydroxide, and tetra-n-decylammonium hydroxide.

The generic reaction scheme for neutralization involving a monoammonium salt is as follows:

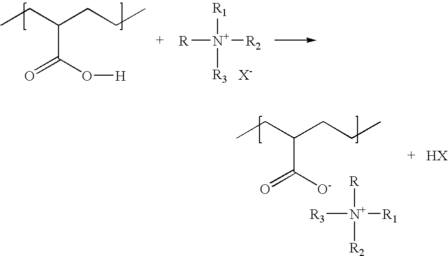

where R, R₁, R₂, and R₃ may be hydrogen, any linear or branched alkyl group having from about 1 to about 50 carbon atoms, preferably about 1 to about 20 carbon atoms, or from about 1 to about 12 carbon atoms, aryl group, phenyl group, a cyclic group, or mixture thereof, and where X— may be any one of fluoride, chloride, bromide, iodide, hydroxide, and mixtures thereof. The organic groups R, R₁, R₂, and R₃ may be the same or different from each other.

Likewise, the generic reaction scheme for neutralization involving a diammonium salt is as follows:

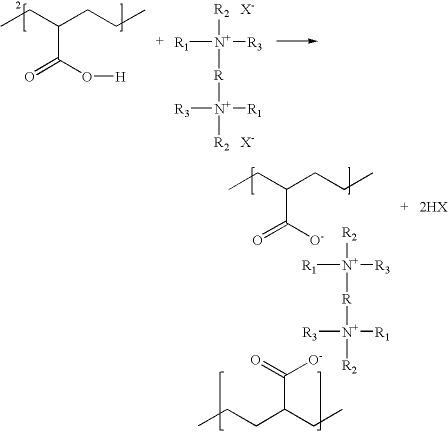

where R may be any linear or branched alkyl group, i.e., any (CH₂)ₙ group, cycloalkyl group, aryl group, carboxylic group, aromatic group, heterocyclic group, or mixture thereof, where R₁, R₂, and R₃ may be hydrogen, any linear or branched alkyl group having from about 1 to about 50 carbon atoms, preferably about 1 to about 20 carbon atoms, or from about 1 to about 12 carbon atoms, aryl group, phenyl group, a cyclic group, or mixture thereof, and where X⁻ may be any one of fluoride, chloride, bromide, iodide, hydroxide, carbonate, other suitable anionic moiety and mixtures thereof. The organic groups R₁, R₂, and R₃ may be the same or different from each other.

A variety of amine-based neutralizing agents may also be used in compositions of the present invention. For example, a highly neutralized ionomer composition may be formed by adding an amine-based component (or a derivative thereof) to an acid copolymer, partially neutralized ionomer, or a mixture thereof. In general, an amine-based component according to the present invention include primary amines, secondary amines, tertiary amines having one of the following general formulae:

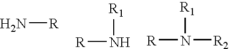

where R, R₁, and R₂ may be hydrogen, any linear or branched alkyl group having from about 1 to about 50 carbon atoms, preferably about 1 to about 30 carbon atoms, or from about 1 to about 12 carbon atoms, aryl group, phenyl group, a cyclic group, or mixture thereof. The organic groups R, R₁, and R₂ may be the same or different from each other.

An example of an amine-based component contemplated for use as a neutralizing agent of the present invention is a monoamine, i.e., an organic compound containing a single amino group. Skilled artisans understand and are aware of methods of forming monoamine salts that may be used in compositions of the present invention. For example, monoamines may be formed by the reaction of a monohydric alcohol initiator with ethylene and/or propylene oxide, followed by the conversion of the resulting terminal hydroxyl group to an amine, yielding the following generic structure:

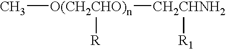

wherein R and R₁ may be hydrogen or methyl groups, and n is preferably tailored so that the overall ethylene oxide/propylene oxide ratio of the molecule is about 70 to 30. A non-limiting commercially available example of such a monoamine includes JEFFAMINE® M-2070, which has the following structure:

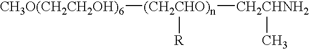

wherein R may be a hydrogen or a methyl group, and n is tailored so that the overall ethylene oxide/propylene oxide ratio of the molecule is about 70 to 30.

Generic reaction schemes for neutralization of an acid copolymer with an amine-based component according to the present invention include the following:

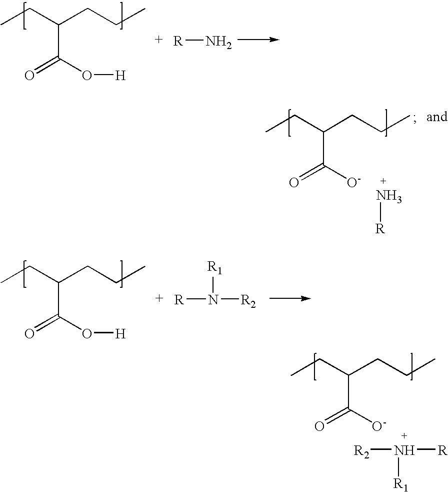

where R, R₁, R₂, and R₃ may be hydrogen, any linear or branched alkyl group having from about 1 to about 50 carbon atoms, preferably about 1 to about 30 carbon atoms, or from about 1 to about 12 carbon atoms, aryl group, phenyl group, a cyclic group, or mixture thereof. The organic groups R, R₁, and R₂ may be the same or different from each other.

Primary, secondary, and tertiary amine salts are also contemplated for use as neutralizing agents according to the invention. For example, monoamine salts may then be readily formed by reacting a monoamine with a variety of organic and inorganic acids. The general reaction scheme is shown below:

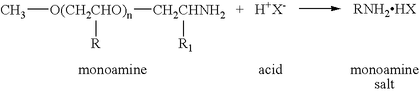

wherein R and R₁ are hydrogen or methyl groups, n is preferably tailored so that the overall ethylene oxide/propylene oxide ratio of the molecule is about 70 to 30, and X⁻ may be may be any one of fluoride, chloride, bromide, iodide, hydroxide, and mixtures thereof.

One possible generic reaction scheme for neutralization of an acid copolymer with an amine salt according to the present invention is as follows:

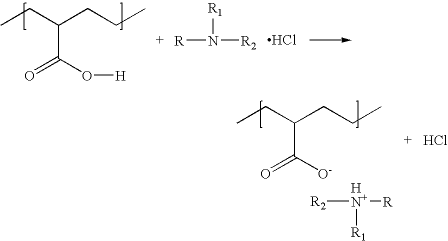

where R, R₁, R₂, and R₃ may be hydrogen, any linear or branched alkyl group having from about 1 to about 50 carbon atoms, preferably about 1 to about 20 carbon atoms, or from about 1 to about 12 carbon atoms, aryl group, phenyl group, a cyclic group, or mixture thereof. The organic groups R, R₁, and R₂ may be the same or different from each other. Examples of ethylene methacrylic acid and ethylene acrylic acid copolymers and their terpolymers are sold commercially under the trade names NUCREL®, ESCOR®, or PRIMACOR®, which are manufactured by DuPont, Exxon and Dow Chemical, respectively.

The salts contemplated as neutralizing components according to the invention may also be the reaction product of an olefin having from 2 to 10 carbon atoms and an unsaturated monocarboxylic acid having 3 to 8 carbon atoms. Ethylene methacrylic acid ionomers and ethylene acrylic acid ionomers and their terpolymers are sold commercially under the trade names SURLYN® and IOTEK® which are manufactured by DuPont and Exxon, respectively.

Other examples of amine-based and ammonium-based neutralizing components that may be used in compositions of the present invention include primary, secondary, and tertiary diamines, which have the following general formulae:

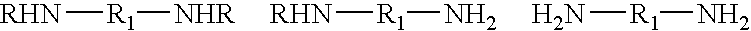

where R is any linear or branched alkyl group having from about 1 to about 50 carbon atoms, preferably about 1 to about 30 carbon atoms, or from about 1 to about 12 carbon atoms, an aryl group, a phenyl group, a cyclic group, or mixture thereof, and where R₁ may be any linear or branched alkyl group, carboxylic group, aromatic group, heterocyclic group, or mixture thereof.

Generic reaction schemes for neutralization of an acid copolymer with a diamine according to the present invention include the following:

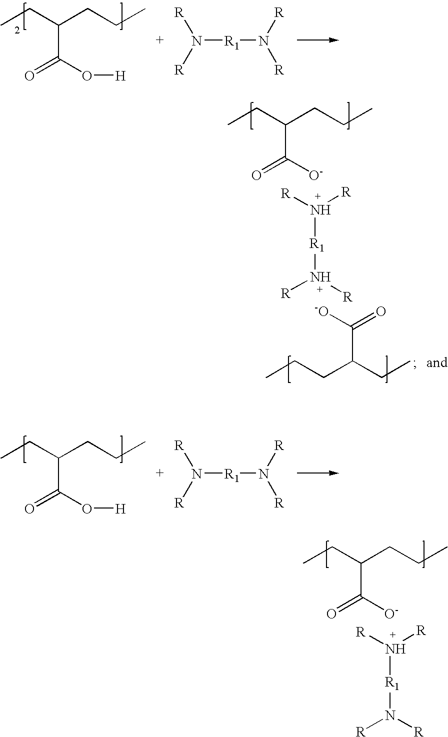

where R may be hydrogen, any linear or branched alkyl group having from about 1 to about 50 carbon atoms, preferably about 1 to about 30 carbon atoms, or from about 1 to about 12 carbon atoms, aryl group, phenyl group, a cyclic group, or mixture thereof, and where R₁ may be any linear or branched alkyl group, i.e., any (CH₂)ₙ group, cycloalkyl group, aryl group, carboxylic group, aromatic group, heterocyclic group, or mixture thereof. The organic groups R, R₁, and R₂ may be the same or different from each other.

Suitable plasticizing components of the invention include, but are not limited to, inner salts, chelates and ligands thereof, anionic, cationic, non-ionic, and amphoteric surfactants, phospholipids, ionic liquids, long-chain organic carbonates, main-chain heteroatom-substituted fatty acids, polar waxes, and mixtures thereof. For example, one method of obtaining a highly neutralized or fully neutralized polymer composition of the present invention is to prepare blends of acid copolymers with a sufficient metal source known in the art, e.g. ZnO, Mg(OH)₂, and a suitable plasticizer of the invention. In addition, highly or fully neutralized polymer compositions of the invention may be formed by exposing a partially neutralized polymer to a plasticizer of the invention. Moreover, a blend of an acid copolymer and a partially neutralized polymer may be neutralized with a plasticizer of the invention to form a highly neutralized or fully neutralized polymer composition of the invention.

An inner salt according to the invention can be any electrically neutral molecule carrying both a positive and negative charge in one of the major canonical descriptions. Inner salts are also sometimes referred to as zwitterionic compounds and amphoteric compounds, among other terms. As such, inner salts according to the invention include ylides. Ylides are defined as compounds in which an anionic site Y⁻ is attached directly to heteroatom X⁺ (usually nitrogen, phosphorous, or sulfur) carrying a formal positive charge. Examples of ylides include, but are not limited to, nitrogen ylides such as amine or ammonium ylides (R₃M⁺-C⁻R₂), azomethine ylides (R₂C═N⁺R—C₋R₂), and nitrile ylides (RC≡N⁺—C⁻R₂); phosphorus ylides; oxygen ylides; and sulfur ylides.

Inner salts may also be referred to as dipolar compounds, although this reference is actually a misnomer. For example, inner salts according to the invention include, but are not limited to 1,3-dipolar compounds in which a significant canonical resonance form can be represented by a separation of charge over three atoms. As can be seen below, there is overlap between the various “names” for inner salts used in this section. For instance, some of the ylides discussed above appear in the following subclasses of dipolar compounds:

i) Allyl type, which can be presented by the following general formula:

X═Y⁺-Z⁻ [symbol] ⁻X—Y⁺=Z [symbol] ⁺X—Y-Z⁻ [symbol] ⁻X—Y-Z⁺

where X and Z can be carbon, nitrogen, or oxygen and Y can be either nitrogen or oxygen. Some examples of allyl type dipolar compounds include nitrones, nitro compounds, oxonium ylides, azo imides, azomethine imides, azomethine ylides, azoxy compounds, carbonyl imides, carbonyl oxides, and carbonyl ylides;

ii) Propargyl type, which can be presented by the following general formula:

X≡N⁺-Z⁻ [symbol] ⁻X═N⁺=Z [symbol] ^{-X═N-Z}⁺ [symbol] X—N=Z

where X can be carbon or oxygen and Z can be carbon, nitrogen or oxygen. Some examples of propargyl type include nitrile imides, nitrile oxides, nitrile ylides, nitrilium betaines, azides, and diazo compounds; and

iii) Carbene type, which can be presented by the following general formula:

:X—C=Z [symbol] ⁺X═C-Z⁻

where X can be carbon or nitrogen and Z can be carbon, nitrogen or oxygen. Some examples of carbene type include acyl carbenes (RC(═O)C:R), imidoyl carbenes (RC(═NR)C:R), and vinyl carbenes (R₂C═CRCR: [symbol] R₂C+CR═C—R:). For instance, this type of dipolar compound can be obtained as follows:

RN⁻—N⁺≡N [symbol] RN═N⁺═N⁻ [symbol] RN^{-—N═N}⁺; or

RC≡N⁺—O⁻ [symbol] RC⁻═N⁺═O [symbol] RC⁺═N—O⁻.

As can be seen in the description of propargyl type dipolar compounds above, inner salts according to the invention may also be referred to as betaines, i.e., neutral molecules having charge-separated forms with an onium atom that bears no hydrogen atoms and that is not adjacent to the anionic atom. Non-limiting examples of suitable betaines are represented by the following structures:

(CH₃)₃P⁺CH₂S(═O)₂O⁻ and (Ph₃)₃P⁺CH₂ CH₂O⁻.

In addition, mesoionic compounds, which are dipolar five- (possibly six-) membered heterocyclic compounds in which both the negative and positive charge are delocalized, are a subclass of betaines. The formal positive charge is associated with the ring atoms and the formal negative charge is associated with ring atoms or an exocyclic nitrogen or chalcogen atom. An example of a mesionic compound includes, but is not limited to the following:

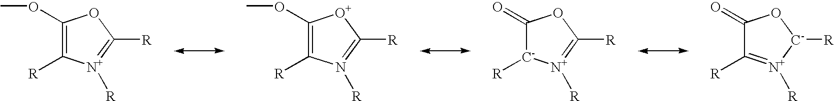

As discussed briefly above, an inner salt may be blended with an acid copolymer, e.g., an ethylene-acid copolymer, in the presence of a metal source such as zinc oxide to form the highly neutralized or fully neutralized polymer compositions of the invention. In addition, an inner salt may be made in-situ by adding the organic portion of the inner salt with the metal source or other counterion to create the salt upon processing.

In addition to inner salts, chelates and ligands thereof may be used as a plasticizer of the invention. Chelates are also known as sequestering agents, complexing agents, and coordination agents. For the purposes of the present invention, references to chelates also refers to any ligands thereof.

A chelate is composed of a metal ion and a chelating agent. Suitable metal ions include titanium, nickel, vanadium, chromium, manganese, iron, cobalt, nickel, and copper. Suitable chelating agents include any substance whose molecules can form several bonds to a single metal ion, also known as a multidentate ligand. Non-limiting examples of chelating agents include ethylene diamine and porphyrins.

As such, examples of suitable chelates include, but are not limited to, beta-diketonates, crown ethers, thiacrown ethers, calixarenes, porphyrins, macrocyclic antibiotics, cryptands, and ethylenediaminetetraacetic acid (EDTA). Suitable beta-diketonates include, but are not limited to thallium (I) acetylacetonate, thallium (I) acetylacetonate, thallium (I) benzoylacetonate, thallium (I) benzoylacetonate, titanium (IV) oxide bis(acetylacetonate), and titanium (IV) oxide bis(acetylacetonate).

Crown ethers include heterocyclic chemical compounds that, in their simplest form, are cyclic oligomers of ethylene oxide. Non-limiting examples of crown ethers suitable for use as plasticizers according to the present invention include the following:

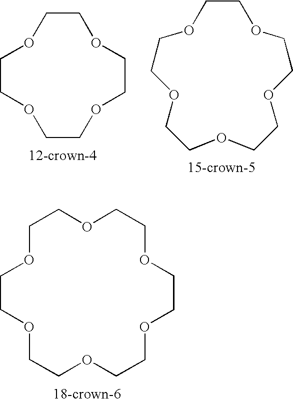

Thiacrown ethers and azacrown ethers are also contemplated for use as suitable plasticizers according to the present invention. For example, 9-thiacrown-3, 12-thiacrown-4, 15-thiacrown-5, and 18-thiacrown-6 are suitable as plasticizers of the present invention. In addition, thiacrown ethers are contemplated for use as suitable plasticizers according to the present invention. In addition, suitable azacrown ethers for use with the present invention include any crown ether that has nitrogen donor atoms as well as oxygen donor atoms to coordinate to the metal iron.

Calixarenes are macrocycles or cyclic oligomers based on the hydroxyalkylation product of a) an aromatic component with at least one hydroxy group, such as phenol, resorcinol, p-cresol, or pyrogallol and b) an aldehyde. Calixarene nomenclature is straightforward and involves counting the number of repeating units in the ring and include it in the name. For example, calix[4]arene has 4 units in the ring, calix[5]arene has 5, and calix[6]arene has 6. Those of ordinary skill in the art would be aware of the methods for synthesizing a calixarene. For instance, with phenol, the aldehyde most often used is simply formaldehyde, while larger aldehydes (acetaldehyde, or larger) are generally required in condensation reactions with resorcinol and pyrogallol. In addition, calix[5]arenes may be produced by a stepwise synthesis of p-cresol and an aldehyde.

Another set of suitable chelates is the pophyrins, the core structure of which is:

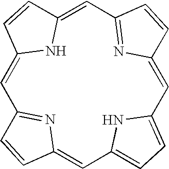

Suitable pophyrins include any heterocyclic macrocycle made from 4 pyrrole subunits linked on opposite sides (α position) through 4 methine bridges (═CH—). Specific examples include, but are not limited to, heme, chlorophyll, and B-12. Those of ordinary skill in the art would be aware of suitable methods for deriving a prophyrin for use as a plasticizer of the invention. For example, porphine, which is the simplest porphyrin chelating agent, forms bonds to a metal ion through nitrogen atoms, where each of its four nitrogen atoms in the center of the molcule can form a bond to a metal ion. Other prophyrins may be derived from porphine by replacing some of the outside hydrogen atoms with other groups of atoms.

Macrocyclic antibiotics for use with the present invention include any antibiotic with antibiotic at least one macrocyclic ring structure. In one embodiment, the ring structure contains at least about 10 members and more preferably at least about 15 members. Non-limiting examples of suitable macrocyclic antibiotics include rifamycin, avoparcin, vancomycin, teicoplanin, ristocetin A, valinomycin, and thiostrepton. In addition, macrocyclic antibiotics are contemplated for use with the present invention.

As discussed briefly above, cryptands are suitable chelates according to the invention. Suitable cryptands include, but are not limited to molecular entities including cyclic or polycyclic assemblies of binding sites that contain three or more binding sites held together by covalent bonds and defines a molecular cavity in such a way as to bind a visitor molecule, i.e., a cation, anion, or neutral species. An important feature of this type of moleclue is that all of the binding sites together hold the visitor molecule more strongly that the individual binding sites alone. In other words, a cryptand is a macropolycyclic polyazo-polyether, where the three-coordinate nitrogen atoms provide the vertices of a three-dimensional structure. The generic structure is:

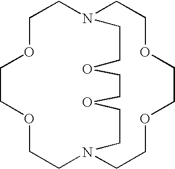

A specific example of a cryptand includes 1,10-diaza-4,7,13,16,21,24-hexaoxabicyclo[8.8.8]hexacosane (N[CH₂CH₂OCH₂CH₂OCH₂CH₂]₃N). Many cryptands are commercially available under the tradename Kryptofix, e.g., Kryptofix 5, Kryptofix 21, Kryptofix 22, Kryptofix 22 aza trisulfate, Kryptofix 22 DD, Kryptofix 22 polymer, Kryptofix 22 polymer (silica gel), Kryptofix 23, Kryptofix 111, Kryptofix 211, Kryptofix 221, Kryptofix 221 B polymer, Kryptofix 222, Kryptofix 222 B, Kryptofix 222 BB, Kryptofix 222 B polymer, Kryptofix 222 CC, and Kryptofix 222 D.

As mentioned above, EDTA, the structure of which is shown below, is also a suitable chelate for use as a plasticizer of the invention.

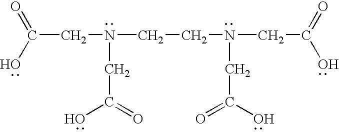

Those of ordinary skill in the art would be aware of suitable methods for forming EDTA. For instance, because EDTA can form four or six bonds with a metal ion and forms chelates with both transition-metal ions and main-group ions, chelation involves the two nitrogen atoms and two oxygen atoms in the separate carboxyl groups.

As with the inner salts discussed above, chelates and ligands thereof may be blended with an acid copolymer in the presence of a metal source to form the highly neutralized or fully neutralized polymer compositions of the invention. In addition, a chelate (or ligand thereof) may be made in-situ by adding the organic portion of the chelate with the metal source or other counterion to create the salt upon processing.

Anionic, cationic, non-ionic, and amphoteric surfactants are also contemplated for use as a plasticizer of the present invention. As such, any water soluble surface-active agent including a hydrophobic portion, usually a long alkyl chain, that is attached to hydrophilic or water solubility enhancing functional groups is suitable for use as a plasticizer. For example, sulfonates and phosphonates, as well as benzyltrimethylammonium hydroxide, and polyoxyethylene 23 lauryl ether (Brij 35), are suitable for use as plasticizers according to the present invention.

In particular, suitable anionic surfactants, which are water soluble and have a negative charge in aqueous solution include, but are not limited to, linear alkylbenzene sulfonates, alcohol ethoxysulfates, linear and branched alkyl sulfates, and soap. In particular, sodium dodecylsulfate, In contrast, cationic surfactants are surfactants that have a positive charge in aqueous solutions, including esterquats, mono alkyl quaternary systems, and quaternary ammonium compounds such as lauryl trimethyl ammonium chloride, stearyl trimethyl ammonium chloride, cetyl trimethyl ammonium chloride, stearyl trimethyl ammonium chloride, di-stearyl dimethyl ammonium chloride, alkylbenzyl dimethyl ammonium chloride, alkylbenzyl dimethyl ammonium chloride. In addition, cationic surfactants suitable for use with the present invention include, but are not limited to, coconut alkyl amine acetate, stearyl amine acetate, and the like.

Suitable non-ionic surfactants, which are in synthetic surfactants and have no charge in aqueous solutions, include, but are not limited to alcohol ethoxylates (ethers of fatty alcohols). Those of ordinary skill in the art would be aware of suitable methods for synthesizing nonionic surfactants for use with the present invention. For example, these surfactants may be prepared by attaching ethylene oxide molecules to a water-insoluble molecule. The properties of the final product depends on the number of ethylene oxides and the number of carbon atoms.

Amphoteric surfactants develop a negative or positive charge depending on whether the solution is alkaline or acidic. Suitable amphoteric surfactants include imidazolines, alkyl betaines, sulfonates, phosphonates, benzyltrimethylammonium hydroxide, and polyoxyethylene 23 lauryl ether.

Several surfactants commercially available from Sigma-Aldrich suitable for use with the present invention include sodium cholate, sodium deoxycholate, N-lauroylsarcosine sodium salt, lauryldimethylamine-oxide, cetyltrimethylammoniumbromide, bis(2-ethylhexyl)sulfosuccinate sodium salt.

The surfactants discussed in this section may be blended with an acid copolymer in the presence of a metal source to form the highly neutralized or fully neutralized polymer compositions of the invention. In addition, the surfactants may be made in-situ by adding the organic portion of the surfactant with the metal source or other counterion to create the salt upon processing.

As discussed above, phospholipids are also suitable plasticizers for use with the present invention. Suitable phospholipids include any lipid formed from the following four components: 1) fatty acids, 2) a negatively-charged phosphate group, 3) nitrogen containing alcohol and 4) a backbone. Without being bound by any particular theory, it is believed that because of the amphiphilic nature of the molecule, i.e., the charges on the phosphate and the amino groups make the head of the molecule hydrophilic, whereas the hydrocarbon chains are hydrophobic, phospholipids can be used to neutralize the acid copolymers in similar ways as the amine-based or ammonium-based components.

Specific examples include, but are not limited to, glycerophospholipids (phosphoglycerides) such as phosphatidyl choline, phosphatidyl ethanolamine, phosphatidyl inositol, phosphatidyl serine, and diphosphatidyl glycerol and sphingomyelin, the general structures of which are shown below:

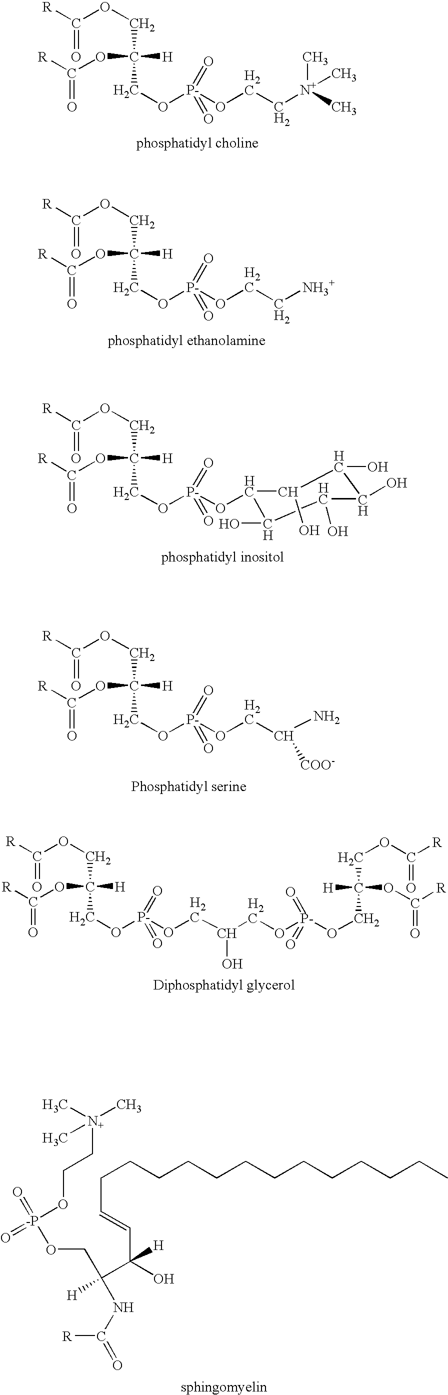

The phospolipids discussed in this section may be blended with an acid copolymer in the presence of a metal source to form the highly neutralized or fully neutralized polymer compositions of the invention. In addition, the phospolipids may be made in-situ by adding the organic portion of the phospolipid with the metal source or other counterion to create the salt upon processing.

Ionic liquids are also proper plasticizers according to the present invention. Generally, an ionic liquid suitable for use with the present invention is an organic salt with a melting point under 100 degrees, often even lower than room temperature. Without being bound by any particular theory, it is believed that the use of an ionic liquid as a plasticizer of the invention is particularly useful because of its beneficial dissolution properties for most organic and inorganic compounds (allowing for optimization of compound characteristics through a broad choice of anion and cation combinations), high thermal stability, and non-flammable character (making it an effective replacement for volatile organic compounds).

For instance, monosubstituted imidazolium dervatives are suitable plasticizers for use with the present invention. Examples of suitable monosubstituted imidazolium dervatives include, but are not limited to, 1-methyl-imidazolium tosylate, 1-methyl-imidazolium tetrafluoroborate, 1-methyl-imidazolium hexafluorophosphate, 1-methyl-imidazolium trifluoromethanesulfonate, 1-butyl-imidazolium tosylate, 1-butyl-imidazolium tetrafluoroborate, 1-butyl-imidazolium hexafluorophosphate, 1-butyl-imidazolium trifluoromethanesulfonate, and mixtures thereof.

In addition, disubstituted imidazolium dervatives are suitable plasticizers for use with the present invention. Examples of suitable disubstituted imidazolium dervatives include, but are not limited to, 1,3-dimethyl-imidazolium methylsulfate, 1,3-dimethyl-imidazolium trifluoromethanesulfonate, 1,3-dimethyl-imidazolium bis(pentafluoroethyl)phosphinate, 1-ethyl-3-methyl-imidazolium chloride, 1-ethyl-3-methyl-imidazolium bromide, 1-ethyl-3-methyl-imidazolium tetrafluoroborate, 1-ethyl-3-methyl-imidazolium tosylate, 1-ethyl-3-methyl-imidazolium dicyanamide, 1-ethyl-3-methyl-imidazolium trifluoromethanesulfonate, 1-ethyl-3-methyl-imidazolium hexafluorophosphate, 1-ethyl-3-methyl-imidazolium hexafluoroantimonate, 1-ethyl-3-methyl-imidazolium bis(pentafluoroethyl)phosphinate, 1-ethyl-3-methyl-imidazolium bis[oxalato(2-)]borate, 1-ethyl-3-methyl-imidazolium bis[1,2-benzenediolato(2-)-O,O]-borate, 1-ethyl-3-methyl-imidazolium bis(trifluoromethyl)imide, 1-ethyl-3-methyl-imidazolium cobalt tetracarbonyl, 1-butyl-3-methyl-imidazolium chloride, 1-butyl-3-methyl-imidazolium bromide, 1-butyl-3-methyl-imidazolium tetrafluoroborate, 1-butyl-3-methyl-imidazolium tosylate, 1-butyl-3-methyl-imidazolium dicyanamide, 1-butyl-3-methyl-imidazolium trifluoromethanesulfonate, 1-butyl-3-ethyl-imidazolium trifluoromethanesulfonate, 1-butyl-3-methyl-imidazolium methylsulfate, 1-butyl-3-methyl-imidazolium hexafluorophosphate, 1-butyl-3-methyl-imidazolium hexafluoroantimonate, 1-butyl-3-methyl-imidazolium bis(trifluoromethyl)imide, 1-ethyl-3-methyl-imidazolium cobalt tetracarbonyl, 1-butyl-3-ethyl-imidazolium trifluoromethanesulfonate, 1-pentyl-3-methyl-imidazolium tris(pentafluoroethyl)trifluorophosphate, 1-pentyl-3-methyl-imidazolium tris(nonafluorobutyl)trifluorophosphate, 1-hexyl-3-methyl-imidazolium chloride, 1-hexyl-3-methyl-imidazolium bromide, 1-hexyl-3-methyl-imidazolium methylsulfate, 1-hexyl-3-methyl-imidazolium tetrafluoroborate, 1-hexyl-3-methyl-imidazolium dicyanamide, 1-hexyl-3-methyl-imidazolium tris(heptafluoropropyl)trifluorophosphate, 1-hexyl-3-methyl-imidazolium hexafluorophosphate, 1-hexyl-3-methyl-imidazolium hexafluoroantimonate, 1-hexyl-3-methyl-imidazolium trifluoromethane sulfonate, 1-hexyl-3-methyl-imidazolium tetracyanoborate, 1-hexyl-3-methyl-imidazolium bis(trifluoromethylsulfonyl)imide, 1-hexyl-3-methyl-imidazolium bis(trifluoromethylsulfonyl)methane, 1-hexyl-3-methyl-imidazoliumtris(pentafluoroethyl)trifluorophosphate, 1-octyl-3-methyl-imidazolium chloride, 1-octyl-3-methyl-imidazolium methylsulfate, 1-octyl-3-methyl-imidazolium tetrafluoroborate, 1-octyl-3-methyl-imidazolium hexafluorophosphate, 1-octyl-3-methyl-imidazolium hexafluoroantimondate, 1-octyl-3-methyl-imidazolium trifluoromethane sulfonate, 1-octyl-3-methyl-imidazolium bis(trifluoromethylsulfonyl)imidie, 1-octyl-3-methyl-imidazolium bis(trifluoromethylsulfonyl)methane, 1-decyl-3-methyl-imidazolium chloride, 1-decyl-3-methyl-imidazolium bromide, 1-dodecyl-3-methyl-imidazolium chloride, 1-tetradecyl-3-methyl-imidazolium chloride, 1-tetradecyl-3-methyl-imidazolium tetrafluoroborate, 1-hexadecyl-3-methyl-imidazolium chloride, 1-octadecyl-3-methyl-imidazolium chloride, 1-octadecyl-3-methyl-imidazolium hexafluorophosphate, 1-octadecyl-3-methyl-imidazolium bis(trifluoromethylsulfonyl)imide, 1-benzyl-3-methyl-imidazolium chloride, 1-benzyl-3-methyl-imidazolium bromide, 1-benzyl-3-methyl-imidazolium methyl sulfate, 1-benzyl-3-methyl-imidazolium hexafluorophosphate, 1-benzyl-3-methyl-imidazolium hexafluoroantimonate, 1-benzyl-3-methyl-imidazolium tetrafluoroborate, 1-benzyl-3-methyl-imidazolium trifluoromethanesulfonate, 1-phenylpropyl-3-methyl-imidazolium chloride, 1-phenylpropyl-3-methyl-imidazolium bromide, 1-phenylpropyl-3-methyl-imidazolium hexafluorophosphate, 1-phenylpropyl-3-methyl-imidazolium hexafluoroantimonate, 1-phenylpropyl-3-methyl-imidazolium tetrafluoroborate, 1-phenylpropyl-3-methyl-imidazolium trifluoromethanesulfonate, and mixtures thereof.

Furthermore, trisubstituted imidazolium dervatives are suitable plasticizers for use with the present invention. Examples of suitable trisubstituted imidazolium dervatives include, but are not limited to, 1-ethyl-2,3-dimethyl-imidazolium chloride, 1-ethyl-2,3-dimethyl-imidazolium bromide, 1-ethyl-2,3-dimethyl-imidazolium methylsulfate, 1-ethyl-2,3-dimethyl-imidazolium tosylate, 1-ethyl-2,3-dimethyl-imidazolium hexafluorophosphate, 1-ethyl-2,3-dimethyl-imidazolium hexafluoroantimonate, 1-ethyl-2,3-dimethyl-imidazolium tetrafluoroborate, 1-ethyl-2,3-dimethyl-imidazolium trifluoromethanesulfonate, 1-butyl-2,3-dimethyl-imidazolium, 1-butyl-2,3-dimethyl-imidazolium chloride, 1-butyl-2,3-dimethyl-imidazolium bromide, 1-butyl-2,3-dimethyl-imidazolium methylsulfate, 1-butyl-2,3-dimethyl-imidazolium tosylate, 1-butyl-2,3-dimethyl-imidazolium tetrafluoroborate, 1-butyl-2,3-dimethyl-imidazolium hexafluorophosphate, 1-butyl-2,3-dimethyl-imidazolium hexafluoro antimonate, 1-butyl-2,3-dimethyl-imidazolium trifluoromethane sulfonate, 1-propyl-2,3-dimethyl-imidazolium chloiride, 1-hexyl-2,3-dimethyl-imidazolium trifluoroborate, 1-hexyl-2,3-dimethyl-imidazolium trifluoromethanesulfonate, 1-hexyl-2,3-dimethyl-imidazolium chloride, 1-hexyl-2,3-dimethyl-imidazolium bromide, 1-hexadecyl-2,3-dimethyl-imidazolium chloride, and mixtures thereof.

Moreover, pyridinium derivatives are useful as plasticizers of the invention. For instance, n-ethyl-pyridinium bromide, n-butyl-pyridinium chloride, n-butyl-pyridinium bromide, n-butyl-pyridinium methylsulfate, n-butyl-pyridinium tetrafluoroborate, n-butyl-pyridinium trifluoromethanesulfonate, n-butyl-pyridinium hexafluorophosphate, n-butyl-pyridinium hexafluoroantimonate, n-butyl-pyridinium bis(trifluoromethyl)imide, n-hexyl-pyridinium chloride, n-hexyl-pyridinium bromide, n-hexyl-pyridinium tetrafluoroborate, n-hexyl-pyridinium hexafluorophosphate, n-hexyl-pyridinium trifluoromethanesulfate, n-hexyl-pyridinium bis(trifluoromethylsulfonyl)methane, n-hexyl-pyridinium tris(trifluoromethylsulfonyl)imide, n-octyl-pyridinium chloride, n-octyl-pyridinium bis(trifluoromethanesulfonyl)methane, n-octyl-pyridinium bis(trofluoromethanesulfonyl)imide, 3-methyl-n-butyl-pyridinium chloride, 3-methyl-n-butyl-pyridinium bromide, 3-methyl-n-butyl-pyridinium methylsulfate, 3-methyl-n-butyl-pyridinium hexafluorophosphate, 3-methyl-n-butyl-pyridinium hexafluoroantimonate, 3-methyl-n-butyl-pyridinium tetrafluoroborate, 3-methyl-n-butyl-pyridinium trifluoromethanesulfonate, 3-methyl-n-hexyl-pyridinium chloride, 3-methyl-n-octyl-pyridinium chloride, 3-ethyl-n-butyl-pyridinium chloride, 3-ethyl-n-butyl-pyridinium bromide, 3-ethyl-n-butyl-pyridinium hexafluorophosphate, 3-ethyl-n-butyl-pyridinium hexafluoroantimonate, 3-ethyl-n-butyl-pyridinium tetrafluoroborate, 3-ethyl-n-butyl-pyridinium trifluoromethanesulfonate, 4-methyl-n-butyl-pyridinium chloride, 4-methyl-n-butyl-pyridinium bromide, 4-methyl-n-butyl-pyridinium tetrafluoroborate, 4-methyl-n-butyl-pyridinium hexafluorophosphate, 4-methyl-n-hexyl-pyridinium chloride, 4-methyl-n-octyl-pyridinium chloride, 3,4-dimethyl-n-butyl-pyridinium chloride, 3,5-dimethyl-n-butyl-pyridinium chloride, and mixtures thereof.

Pyrrolidinium derivatives are also contemplated for use as plasticizers of the invention. Non-limiting examples include 1,1-dimethyl-pyrrolidinium tris(pentafluoroethyl)trifluorophosphate, 1-ethyl-3-methyl-pyrrolidinium bromide, 1-ethyl-1-methyl-pyrrolidinium hexafluorophosphate, 1-ethyl-1-methyl-pyrrolidinium hexafluoroantimonate, 1-ethyl-1-methyl-pyrrolidinium tetrafluoroborate, 1-ethyl-1-methyl-pyrrolidinium trifluoromethanesulfonate, 1-ethyl-1-methyl-pyrrolidinium methylsulfate, 1-ethyl-3-methyl-pyrrolidinium bis(trifluoromethyl)imide, 1-butyl-1-methyl-pyrrolidinium chloride, 1-butyl-1-methyl-pyrrolidinium bromide, 1-butyl-1-methyl-pyrrolidinium methylsulfate, 1-butyl-1-methyl-pyrrolidinium tetrafluoroborate, 1-butyl-1-methyl-pyrrolidinium trifluoromethanesulfonate, 1-butyl-1-methyl-pyrrolidinium hexafluorophosphate, 1-butyl-1-methyl-pyrrolidinium hexafluoroantimonate, 1-butyl-1-methyl-pyrrolidinium dicyanamide, 1-butyl-1-methyl-pyrrolidinium bis(trifluoromethylsulfonyl)imide, 1-butyl-1-methyl-pyrrolidinium tris(pentafluoroethylsulfonyl)trifluorophosphate, 1-butyl-1-methyl-pyrrolidinium tetracyanoborate, 1-butyl-1-ethyl-pyrrolidiniumbromide, 1-hexyl-1-methyl-pyrrolidinium chloride, 1-hexyl-1-methyl-pyrrolidinium dicyanamide, 1-hexyl-1-methyl-pyrrolidinium bis(trifluoromethylsulfonyl)imide, 1-octyl-1-methyl-pyrrolidinium chloride, and mixtures thereof.

In addition to the above plasticizers, phosphonium derivatives are also suitable for use as a plasticizer according to the present invention. In particular, the following are nonlimiting examples of phosphonium derivatives contemplated for use with the present invention: tetrabutyl-phosphonium tris(pentafluoroethyl)trifluorophosphate, tetrabutyl-phosphonium tetracyanoborate, tetrabutyl-phosphonium bis[oxalato(2-)]borate, tetrabutyl-phosphonium bis[1,2-benzenediolato(2-)-O,O′]-borate, tetrabutyl-phosphonium bis(trifluoromethyl)imide, trihexyl(tetradecyl)-phosphonium chloride, trihexyl(tetradecyl)-phosphonium bromide, trihexyl(tetradecyl)-phosphonium dicyanamide, trihexyl(tetradecyl)-phosphonium tetrafluoroborate, trihexyl(tetradecyl)-phosphonium bis(trofluoromethylsulfonyl)imide, trihexyl(tetradecyl)-phosphonium bis(2,4,4-trimethylpentyl)phosphinate, trihexyl(tetradecyl)-phosphonium tris(pentafluoroethyl)trifluorophosphate, trihexyl(tetradecyl)-phosphonium hexafluorophosphate, trihexyl(tetradecyl)-phosphonium decanoate, trihexyl(tetradecyl)-phosphonium tetracyanoborate, trihexyl(tetradecyl)-phosphonium bis[oxalato(2-)]-borate, trihexyl(tetradecyl)-phosphonium bis [1,2-benzenediolato(2-)-O,O′]-borate, trihexyl(tetradecyl)-phosphonium bis(trifluoromethylsulfonyl)methane, benzyltriphenylphosphonium bis(trifluoromethyl)imide, tri-iso-butyl(methyl)-phosphonium tosylate, and mixtures thereof.

Ammonium derivatives are also contemplated for use as a plasticizer. Examples include, but are not limited to, tetramethyl-ammonium bis(trifluoromethylsulfonyl)imide, tetramethyl-ammonium bis(trifluoromethyl)imide, tetramethyl-ammonium tris(pentafluoroethyl)trifluorophosphate, tetramethyl-ammonium bis[oxalato(2-)]-borate, tetraethyl-ammonium bis(trifluoromethyl)imide, tetraethyl-ammonium bis(trifluoromethylsulfonyl)imide, tetraethyl-ammonium tris(pentafluoroethyl)trifluorophosphate, tetraethyl-ammonium bis[1,2-benzenediolato(2-)-O,O′]-borate, tetraethyl-ammonium bis[salicylato(2-)]-borate, tetraethyl-ammonium bis[2,2-biphenyldiolato(2-)-O,O′]-borate, tetraethyl-ammonium bis[malonato(2-)]-borate, tetrabutyl-ammonium bromide, tetrabutyl-ammonium bis(trifluoromethylsulfonyl)imide, tetrabutyl-ammonium tris(pentafluoroethyl)trifluorophosphate, tetrabutyl-ammonium bis(trifluoromethyl)imide, tetrabutyl-ammonium tetracyanoborate, methyltrioctyl-ammonium bis(trifluoromethylsulfonyl)imide, and mixtures thereof.

Suitable guanidinium and isouronium derivatives for use as plasticizers of the present invention include, but are not limited to guanidinium tris(pentafluoroethyl)trifluorophosphate, guanidinium trifluoromethane sulfonate, N,N,N′,N′-tetramethyl-N′-ethylguanidinium trifluoromethanesulfonate, N-pentamethyl-N-propylguanidinium tris(pentafluoroethyl) trifluorophosphate, N-pentamethyl-N-propylguanidinium trifluoromethanesulfonate, N-pentamethyl-N-isopropylguanidinium tris(pentafluoroethyl)trifluorophosphate, N-pentamethyl-N-isopropylguanidinium trifluoromethanesulfonate, hexamethylguanidinium tris(pentafluoroethyl)trifluorophosphate, hexamethylguanidinium trifluoromethanesulfonate, 2-methyl-1,1,3,3-tetramethylisouronium tris(pentafluoroethyl)trifluorophosphate, 2-methyl-1,1,3,3-tetramethylisouronium trifluoromethanesulfonate, 2-ethyl-1,1,3,3-tetramethylisouronium tris(pentafluoroethyl)trifluorophosphate, 2-eethyl-1,1,3,3-tetramethylisouronium trifluoromethanesulfonate, and mixtures thereof.

The ionic liquids discussed in this section may be blended with an acid copolymer in the presence of a metal source to form the highly neutralized or fully neutralized polymer compositions of the invention. In addition, the ionic liquids may be made in-situ by adding the organic portion of the ionic liquid with the metal source or other counterion to create the salt upon processing.

Long chain organic carbonates suitable for use as plasticizers of the present invention include chemical compounds containing the carbonate ion, CO₃⁻². Long chain organic carbonates for use with the present invention contain multiple carbon atoms, either in chain or cyclic form. Non-limiting examples include octadecylcarbonate, benzylcarbonate, p-octylbenzylcarbonate, and mixtures thereof, the structures of which are shown generally below:

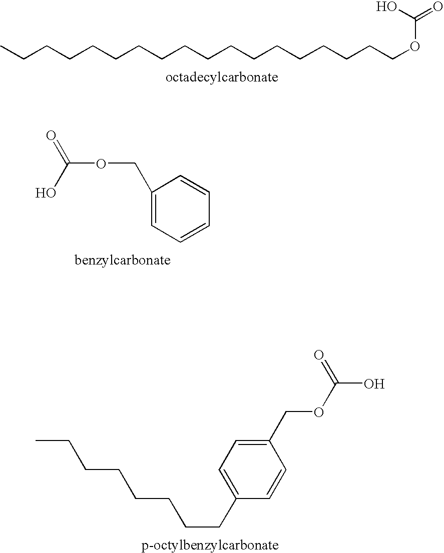

The long chain organic carbonates discussed in this section may be blended with an acid copolymer in the presence of a metal source to form the highly neutralized or fully neutralized polymer compositions of the invention. In addition, the long chain organic carbonates may be made in-situ by adding the organic portion of the long chain organic carbonate with the metal source or other counterion to create the salt upon processing.

Main-chain heteroatom-substituted fatty acids are also suitable for use as plasticizers of the present invention. In particular, the carboxy-terminus of fatty acid analogs with one to three heteroatoms in the fatty acid moiety are modified, to form various amides, esters, ketones, alcohols, alcohol esters and nitrites thereof. The heteroatoms may be oxygen, sulfur, nitrogen, or any combination thereof. The general formula is:

A-Alk₁-B-Alk₂-C-Alk₃(W)—Y

where A can be any one of H, N₃, CN, SH, OH, tetrazolyl, or triazoyl; B and C can independently be any one of O, NR₈, S(O)ₘ, or lower alkylene; Alk₁, Alk₂, or Alk₃ can independently be a branched or unbranched lower alkylene or W substituted lower alkylene (the term W refers to a side chain on Alk₃); Y can be COCl, CONRR₁, CO-AA-OR₃, CONR₂-AA-OR₃, CO₂ , COR₅, CN, CH₂OH, CSNH₂, CH₂O₂CR₆,

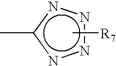

where m is from 0 to 2; W can be any one of OZ, halogen, NR₈, alkyl, aryl, or arylalkyl (with the preferred halogens being chlorine, bromine and fluorine); Z can be any one of H, alkanoyl, aroyl, or arylalkanoyl; and where R, R₁-R₄, and R₇-R₈ independently can be any one of H, alkyl, aryl, or arylalkyl; R5-R6 independently can be any one of alkyl, aryl, or arylalkyl; AA can be any one of D, L, DL or achiral amino acid side chain, provided that when Y═CO₂R₄, R₄ is aryl or arylalkyl, and provided further that at least one of B or C contains a N, O or S heteroatom. In addition, the lower alkylene groups in each of B, C, Alk₁, Alk₂ and Alk₃ can independently contain from one to about 6 carbon atoms but the total number of carbon atoms in the fatty acid chain when B and C are each alkylene preferably should be 11 or 12. Also, when B and/or C are any of the heteroatoms O, S(O)ₘ and NR₈, each of these heteroatoms replaces a methylene group in the fatty acid chain. Furthermore, the alkyl moieties in any of the R to R₈ groups preferably contain from 1 to 12 carbon atoms whereas the aryl and arylalkyl moieties in any of the R to R₈ groups preferably contain from 6 to 12 carbon atoms. The alkyl and alkylene groups can be saturated or unsaturated.

The main-chain heteroatom-substituted fatty acids discussed in this section may be blended with an acid copolymer in the presence of a metal source to form the highly neutralized or fully neutralized polymer compositions of the invention. In addition, the main-chain heteroatom-substituted fatty acids may be made in-situ by adding the organic portion of the main-chain heteroatom-substituted fatty acid with the metal source or other counterion to create the salt upon processing.

Polar waxes can also be used as plasticizers according to the present invention. Suitable polar waxes incorporate at least one polar group, including hydroxyl, primary, secondary, and tertiary amides, sulfones, sulfonate salts, phosphate esters, sulfonamide, carbonate, urea, amine, urethane, carboxylic acids and carboxylic salts, per wax molecule. As known to those of ordinary skill in the art, higher concentrations of polar groups are necessary for higher molecular weight waxes.

Nonlimiting examples of suitable crystalline polar waxes include 12-hydroxystearamide, N-(2-hydroxy ethyl) 12-hydroxystearamide (PARICIN 220 commercially available from CasChem), stearamide (KEMAMIDE S commercially available from Witco), glycerin monostearate, sorbitan monostearate, and 12-hydroxy stearic acid. Also useful in combination with the above are the less polar waxes such as N,N′-ethylene-bis-stearamide (KEMAMIDE W40 commercially available from Witco), hydrogenated castor oil (castor wax), oxidized synthetic waxes, and functionalized synthetic waxes such as oxidized polyethylene waxes (PETROLITE E-1040).

The polar waxes discussed in this section may be blended with an acid copolymer in the presence of a metal source to form the highly neutralized or fully neutralized polymer compositions of the invention. In addition, the polar waxes may be made in-situ by adding the organic portion of the polar wax with the metal source or other counterion to create the salt upon processing.

It should be noted that any acid copolymer may be used in the compositions of the invention. For example, the compositions of the invention may include an acid copolymer having the following general formula:

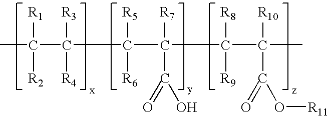

where R₁-R₆ and R₈-R₉ may be hydrogen, a brached or linear alkyl group, carbocylic group, aromatic group, or heterocyclic group, where R₇ and R₁₁ may be hydrogen or a lower alkyl group, where R₁₁ may be any linear or branched alkyl group, preferably methyl, ethyl, propyl, butyl, pentyl, hexyl, hectyl, octyl, or isobornyl, and where x is preferably from 50 to 99 weight percent, where y is preferably 1 to 50 weight percent, and where z is preferably 0 to 50 weight percent. Thus, the term acid copolymer in this application means two or more monomers of x, y, or z above. More specifically, “acid copolymers” include copolymers of an olefin and an α,β-unsaturated carboxylic acid. In one embodiment, suitable acid copolymers may include olefin-unsaturated carboxylic acid random copolymer, any olefin-unsaturated carboxylic acid-unsaturated carboxylate ternary copolymer, and mixtures thereof.

Furthermore, the compositions of the invention may include partially neutralized polymers that are further neutralized with any of the neutralizing components or plasticizers of the invention (or mixtures thereof). As used herein, a “partially neutralized polymer” is a polymer that has a portion of its acid groups neutralized. For example, any traditional partially neutralized ionomer, i.e., a salt of an acid copolymer formed by neutralizing a portion, i.e., less than about 70 percent, of the carboxylic acid groups on the polymer with at least one metal atom, such as lithium, sodium, potassium, cesium, magnesium, calcium, barium, zinc, manganese, copper, and aluminum, may be further neutralized in this manner because these type of ionomers still include unneutralized acid groups. In addition, a partially neutralized polymer may include a polymer where the acid groups have been neutralized with salts of organic fatty acids and a suitable cation source.

In one embodiment, olefin-unsaturated carboxylic acid random copolymers or any olefin-unsaturated carboxylic acid-unsaturated carboxylate ternary copolymers with the acid groups neutralized by about less than about 70 percent may be further neutralized with any of the neutralizing components or plasticizers of the invention to form a highly or fully neutralized polymer composition.

The acid copolymer or partially neutralized ionomer may also be selected from so-called “low acid” and “high acid” polymer, as well as blends thereof. For purposes of this application, ionic copolymers including up to about 12 weight percent acid are considered “low acid” polymer, while those greater than about 12 weight percent acid but less than about 16 weight percent acid are “medium acid” polymer, and those having about 16 weight percent or greater acid are considered “high acid” polymers.

In one embodiment, the acid copolymer or partially neutralized polymer may be one in which the acid is present in about 5 to 15 weight percent, i.e., a low to medium acid polymer. In another embodiment, the acid copolymer or partially neutralized polymer is a high acid copolymer or ionomer, which, when used in golf balls, is believed to aid in producing a golf ball with low spin rate and maximum distance. In this aspect, the acrylic or methacrylic acid is present in about 16 to about 35 weight percent, making the ionomeric material a high modulus material. In one embodiment, the high modulus material includes about 16 percent by weight of a carboxylic acid, preferably from about 17 percent to about 25 percent by weight of a carboxylic acid, more preferably from about 18.5 percent to about 21.5 percent by weight of a carboxylic acid.

In one embodiment, the acid copolymer and/or partially neutralized polymer contain a softening comonomer. For example, the acid copolymer may be an E/X/Y terpolymer where E is ethylene, X is an acrylate or methacrylate-based softening comonomer present in about 0 to 50 weight percent, and Y is acrylic or methacrylic acid. According to the discussion above, the acrylic or methacrylic acid (Y) can be present in an amount up to about 12 weight percent (low acid), from about 12 weight percent but less than 16 weight percent (medium acid), or about 16 weight percent or greater (high acid). In one embodiment, Y is present in an amount of about 5 to 35 weight percent, preferably about 5 to 30 weight percent, more preferably 8 to 25 weight percent, and most preferably 8 to 20 weight percent. In this aspect, a partially neutralized polymer according to the invention that includes a softening comonomer may be an E/X/Y terpolymer as described above with the acid groups at least partially neutralized to about 70 percent with salts of zinc, sodium, lithium, magnesium, potassium, calcium, manganese, nickel or the like. The softening comonomer may be selected from the group consisting of vinyl esters of aliphatic carboxylic acids wherein the acids have 1 to 10 carbon atoms, vinyl ethers wherein the alkyl groups contains 1 to 10 carbon atoms, and alkyl acrylates or methacrylates wherein the alkyl group contains 1 to 10 carbon atoms. Suitable softening comonomers include vinyl acetate, methyl acrylate, methyl methacrylate, ethyl acrylate, ethyl methacrylate, butyl acrylate such as iso- or n-butyl acrylate, butyl methacrylate, or the like.

Consequently, examples of a number of copolymers suitable for use according to the present invention include, but are not limited to, high acid embodiments of an ethylene/acrylic acid copolymer, an ethylene/methacrylic acid copolymer, an ethylene/itaconic acid copolymer, an ethylene/maleic acid copolymer, an ethylene/methacrylic acid/vinyl acetate copolymer, an ethylene/acrylic acid/vinyl alcohol copolymer, and the like.

For example, a neutralizing and/or plasticizing component of the invention may be mixed with copolymers or terpolymers of ethylene and methacrylic acid or acrylic acid at least partially neutralized to about 10 to about 70 percent with salts of zinc, sodium, lithium, magnesium, potassium, calcium, manganese, nickel or the like, to form highly neutralized or fully neutralized ionomer compositions of the present invention.

While the reaction procedure is not critical, one suitable method for preparing the neutralized compositions of the invention includes mixing the neutralizing component, i.e., monoamine and/or ammonium salt, or plasticizing component with an acid copolymer previously dissolved in a solvent. For example, in one embodiment, a neutralizing component, plasticizing component, or both is made in concentrated form and then mixed with an acid copolymer. Another suitable method may include reacting an acid copolymer with a metal ion to partially neutralize the acid copolymer and then mixing a neutralizing component, a plasticizing component, or both with the partially neutralized ionomer. In addition, the simultaneous mixing of the acid copolymer, metal ion, and neutralizing component, plasticizing component, or both may produce the highly neutralized ionomer compositions of the invention.

The mixing step may be carried out at a temperature above the melting point of the composition to be formed. In one embodiment, the mixing step is carried out to a temperature of at least about 95° C., while in another embodiment the mixing step is carried out at a temperature of from about 95° C. to about 200° C. Selection of the temperature at which mixing occurs may depend in part upon the selected ingredients or components of the composition. Skilled artisans may understand that different mixing temperatures may be used for different compositions such as to prevent thermal degradation of the composition. For instance, excess temperature will convert the neutralized polymer to the corresponding ester.

Those of ordinary skill in the art are aware of the equipment well suited to perform such mixing. For example, heat mixing may be achieved by mixing the components in an internal mixer, such as a twin-screw extruder, a Banbury mixer, or a kneader, operating at a suitable temperature, such as from about 95° C. to about 200° C. Where various additives are to be added (as discussed below), any suitable method may be used to incorporate the additives together with the essential components. For example, the essential components and the additives are simultaneously heated and mixed. Alternatively, the essential components are premixed before the additives are added and the overall composition heated and mixed.

The flexural modulus of the highly neutralized ionomer composition may be from about 5,000 psi to about 150,000 psi, preferably about 10,000 psi to about 150,000 psi. In one embodiment, the highly neutralized ionomer composition has a flexural modulus of about 25,000 psi to about 75,000 psi. In addition, the hardness of the highly neutralized ionomer composition is about 30 Shore D to about 80 Shore D. In one embodiment, the hardness is about 30 Shore D to about 70 Shore D. In another embodiment, the hardness is about 40 Shore D to about 70 Shore D.

As discussed, the highly neutralized ionomer compositions of the invention preferably have a melt flow index optimal for processability. Therefore, the highly neutralized ionomer compositions of the present invention preferably have a melt flow index of about 0.5 g/10 min or greater at a temperature of 190° C. under a load of about 2100 g, according to ASTM test D-1238. In addition, the melt flow index of the highly neutralized ionomer is preferably no greater than about 20 g/10 min, preferably about 15 g/10 min or less. In one embodiment, the melt flow index of the highly neutralized ionomer composition is about 1.0 g/10 min or greater. In yet another embodiment, the melt flow index is about 1.5 g/10 min or greater. In still another embodiment, the melt flow index is about 2 g/10 min or greater.

The specific gravity of the highly neutralized ionomer is not critical, however, preferably the specific gravity is about 0.9 or greater. In one embodiment, the specific gravity of the highly neutralized ionomer is about 1.5 or less. For example, the specific gravity of the highly neutralized ionomer may be from about 0.9 to about 1.3.

The highly neutralized ionomer compositions of the invention described above may also include various additives. For example, fillers may be added to the compositions of the invention to affect theological and mixing properties, the specific gravity, i.e., density-modifying fillers, the modulus, the tear strength, reinforcement, and the like. The fillers are generally inorganic, and suitable fillers include numerous metals, metal oxides and salts, such as zinc oxide and tin oxide, as well as barium sulfate, zinc sulfate, calcium oxide, calcium carbonate, zinc carbonate, barium carbonate, clay, tungsten, tungsten carbide, an array of silicas, regrind (recycled core material typically ground to about 30 mesh particle), high-Mooney-viscosity rubber regrind, and mixtures thereof.

In one embodiment, the compositions of the invention can be reinforced by blending with a wide range of density-adjusting fillers, e.g. ceramics, glass spheres (solid or hollow, and filled or unfilled), and fibers, inorganic particles, and metal particles, such as metal flakes, metallic powders, oxides, and derivatives thereof, as is known to those with skill in the art. The selection of such filler(s) is dependent upon the type of golf ball desired, i.e., one-piece, two-piece, multi-component, or wound, as will be more fully detailed below. In another embodiment, the filler will be inorganic, having a density of greater than 4 g/cc, and will be present in amounts between about 5 and about 65 weight percent based on the total weight of the polymer composition.

The compositions of the invention may also be foamed by the addition of the at least one physical or chemical blowing or foaming agent. The use of a foamed polymer allows the golf ball designer to adjust the density or mass distribution of the ball to adjust the angular moment of inertia, and, thus, the spin rate and performance of the ball. Foamed materials also offer a potential cost savings due to the reduced use of polymeric material. As used herein, the term “foamed” encompasses “conventional foamed” materials that have cells with an average diameter of greater than 100 μm and “microcellular” type materials, i.e., cells with an average diameter from about 0.1 to 100 μm, so that about 5 to about 30 percent void fractions and void sizes on the order of 8 μm or less have been produced. In this embodiment, the polymer blend may be foamed during molding by any conventional foaming or blowing agent. Preferably, foamed layers incorporating an oxa ester or oxa ester blend have a flexural modulus of at least about 1,000 psi to about 150,000 psi.

Useful blowing or foaming agents include, but are not limited to, organic blowing agents, such as azobisformamide; azobisisobutyronitrile; diazoaminobenzene; N,N-dimethyl-N,N-dinitroso terephthalamide; N,N-dinitrosopentamethylene-tetramine; benzenesulfonyl-hydrazide; benzene-1,3-disulfonyl hydrazide; 4,4′-oxybis benzene sulfonyl hydrazide; p-toluene sulfonyl semicarbizide; barium azodicarboxylate; butylamine nitrile; nitroureas; trihydrazino triazine; peroxides; and inorganic blowing agents such as ammonium bicarbonate and sodium bicarbonate. A gas, such as air, nitrogen, carbon dioxide, and the like, may also be injected into the composition during the injection molding process.

A foamed composition of the present invention may also be formed by blending microspheres with the composition either during or before the molding process. Polymeric, ceramic, metal, and glass microspheres are useful in the invention, and may be solid or hollow and filled or unfilled. In particular, microspheres up to about 1000 μm in diameter are useful. Generally, either injection molding or compression molding may be used to form a layer or a core including a foamed polymeric material.

Other materials conventionally included in golf ball compositions may also be added to the compositions of the invention. These additional materials include, but are not limited to, reaction enhancers, crosslinking agents, optical brighteners, coloring agents, fluorescent agents, whitening agents, UV absorbers, hindered amine light stabilizers, defoaming agents, processing aids, mica, talc, nano-fillers, and other conventional additives. Antioxidants, stabilizers, softening agents, plasticizers, including internal and external plasticizers (separate and distinct from the categories of plasticizers discussed above for use in neutralizing the compositions of the invention), impact modifiers, foaming agents, excipients, reinforcing materials and compatibilizers may also be added to any composition of the invention. In addition, heat stabilizers may be beneficial in enlarging the range of processing temperatures to greater than about 130° C. All of these materials, which are well known in the art, are added for their usual purpose in typical amounts.

The highly or fully neutralized polymers of the present invention may be present in a blend. For example, a blend may include about 1 percent to about 99 percent of a highly neutralized polymer and about 99 percent to about 1 percent other polymer or component based on the total weight of the blend. In another embodiment, the highly neutralized polymer is present in an amount of about 95 percent to about 5 percent with about 5 percent to about 95 percent of one or more other polymers or components making up the rest of the blend. In yet another embodiment, the highly neutralized polymer is present in an amount of about 95 percent to about 10 percent by weight of the blend, and at least one other polymer or component is present in an amount of about 5 percent to about 90 percent by weight of the blend. In still another embodiment, the highly neutralized polymers of the present invention are present in an amount from about 25 to about 90 percent by weight of the composition. In yet another embodiment, about 30 to about 85 weight percent of the composition is a highly fully neutralized polymer.

Highly neutralized or fully neutralized compositions of the present invention may be produced by blending compositions that are neutralized in different ways. For instance, an acid copolymer that is neutralized with any of the neutralizing components and/or plasticizers listed above or a partially neutralized polymer that is further neutralized with any of the neutralizing components and/or plasticizers of the invention may be blended with a partially, highly, or fully neutralized polymer that has been neutralized using conventional methods.

In one embodiment, the composition is highly or fully neutralized and is a blend in approximately equal amounts of a) a copolymer neutralized with the neutralizing and/or plasticizers of the invention and b) a copolymer neutralized in some other manner. Other blends may also be used. For example, partially neutralized polymers that have been further neutralized with the neutralizing and/or plasticizers of the invention may be blended with any other polymer composition, such as conventionally neutralized polymers or copolymers that are at least partially neutralized with amine or ammonium-based components. The highly neutralized polymers of the invention may also be present in a blend with other acid copolymers or ionomers in any state of neutralization.

The highly neutralized ionomers of the present invention may also be blended with other polymers. For example, the highly neutralized ionomers may be blended with saponified polymers and graft copolymers of saponified polymers or oxa esters and oxa acids.

Other polymers that may be used in conjunction with the highly neutralized compositions of the invention include, but are not limited to: block copolymers of a poly(ether-ester), such as HYTREL® available from DuPont, block copolymers of a poly(ether-amide), such as PEBAX® available from Elf Atofina, styrene-butadiene-styrene block copolymers, such as the KRATON D® grades available from Kraton Polymers, styrene-(ethylene-propylene)-styrene or styrene-(ethylene-butylene)-styrene block copolymers, such as the KRATON G® series from Kraton Chemical, either of the KRATON®s with maleic anhydride or sulfonic graft or functionality, such as the KRATON FD® or KRATON FG® series available from Kraton Polymers, olefinic copolymers, such as the ethylene-acrylate or ethylene methacrylate series available from Quantum, metallocene catalyzed polymers, including ethylene-octene copolymers made from metallocene catalysts, available as the AFFINITY® or ENGAGE® series from Dow, and ethylene-alpha olefin copolymers and terpolymers made from metallocene catalysts, available as the EXACT® series from Exxon, block poly(urethane-ester) or block poly(urethane-ether) or block poly(urethane-caprolactone), such as the ESTANE® series available from Noveon Co., polyethylene glycol, such as CARBOWAX® available from Union Carbide, polycaprolactone, polycaprolactam, polyesters, such as EKTAR® available from Eastman, polyamides, such as nylon 6 or nylon 6,6, available from DuPont and ICI, ethylene-propylene-(diene monomer)terpolymers and their sulfonated or carboxylated derivatives, PP/EPDM and dynamically vulcanized rubbers, such as SANTOPRENE® from Monsanto, and FUSABOND® series materials available from DuPont.

Compositions of the present invention also may be blends with rubber materials. Some examples of rubbers that may be blended include, without limitation, polybutadiene (BR), polyisoprene (IR/NR), styrene-butadiene rubber (SBR), ethylene propylene diene rubber (EPDM), ethylene propylene rubber (EPM), nitrile butadiene rubber (NBR), polychloroprene (CR), polyacrylic rubber (ACM), chlorosulfonated polyethylene (CM).

Blends including the highly neutralized polymers of the invention may be prepared with or without the addition of a compatibilizer, and with varying molecular architecture of blend components, such as varying molecular weight, tacticity, and degrees of blockiness, as is well known to those knowledgeable in the art of blending polymers.

The highly neutralized ionomer compositions of the present invention may be used with any type of ball construction. For example, golf balls formed according to the invention may have a one-piece construction formed from a homogeneous mass consisting entirely of the composition of the invention. Such balls may further include, if desired, blends of conventional materials, such as those discussed herein. One-piece balls, formed with the compositions of the invention, are quite durable, but do not provide great distance because of relatively high spin and low velocity.

Thus, another aspect of the present invention relates to two-piece, three-piece, and four-piece designs, as well as to golf balls having a double core, a double cover, an intermediate layer(s), a multilayer core, and/or a multilayer cover depending on the type of performance desired of the ball. As used herein, the term “layer” includes any generally spherical portion of a golf ball, i.e., a golf ball core or center, an intermediate layer, and/or a golf ball cover. As used herein, the term “multilayer” means at least two layers.

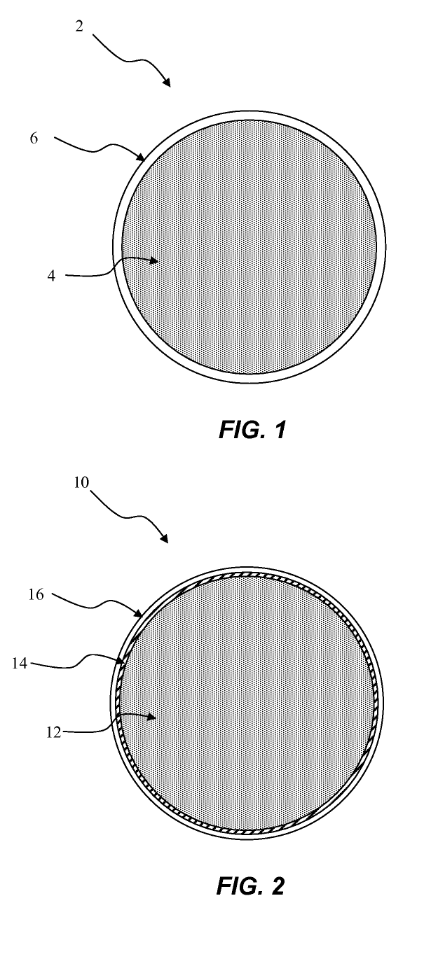

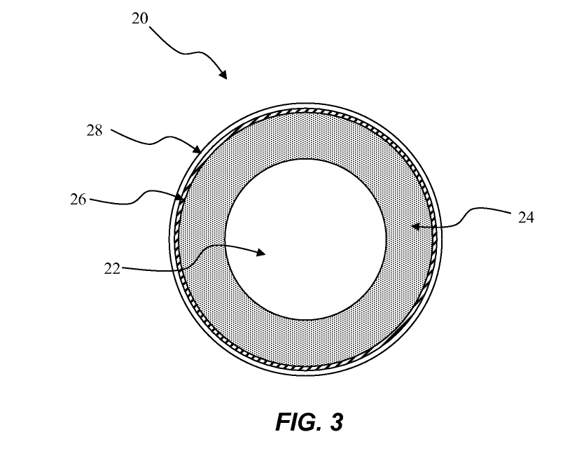

In one embodiment, a golf ball 2 according to the invention (as shown in FIG. 1) includes a core 4 and a cover 6, wherein at least one of core 4 and cover 6 incorporates at least one layer including the highly neutralized ionomer composition of the invention. Similarly, FIG. 2 illustrates a golf ball according to the invention incorporating an intermediate layer. Golf ball 10 includes a core 12, a cover 16, and an intermediate layer 14 disposed between the core 12 and cover 16. Any of the core 12, intermediate layer 14, or cover 16 may incorporate at least one layer that includes the highly neutralized composition of the invention. FIG. 3 illustrates a four-piece golf ball 20 according to the invention including a core 22, an outer core layer or intermediate layer 24, an inner cover layer or intermediate layer 26, and an outer cover layer 28.

As discussed, the golf balls of the invention include at least one layer that includes the highly neutralized polymer compositions of the invention. In addition, as discussed below with specific reference the core, intermediate, and cover layers, the golf balls of the invention may include core layers, intermediate layers, or cover layers formed from materials known to those of skill in the art. These examples are not exhaustive, as skilled artisans would be aware that a variety of materials might be used to produce a golf ball of the invention with desired performance properties.

The cores of the golf balls formed according to the invention may be solid, semi-solid, hollow, fluid-filled, or powder filled. As used herein, the term “core” means the innermost portion of a golf ball, and may include one or more layers. The term “semi-solid” as used herein refers to a paste, a gel, or the like.

While the cores of the invention may be formed with the highly neutralized polymer compositions of the invention, conventional materials may also be used to form the cores. Suitable core materials include, but are not limited to, thermoset materials, such as rubber, styrene butadiene, polybutadiene, isoprene, polyisoprene, trans-isoprene, and polyurethane, and thermoplastic materials, such as conventional ionomer resins, polyamides, polyesters, and polyurethane. In one embodiment, at least one layer of the core is formed from a polybutadiene reaction product.

For example, the core may include a reaction product material formed from the conversion reaction of sufficient amounts of polybutadiene, a free radical source, and a sufficient amount of cis-to-trans catalyst to provide an amount of trans-isomer greater than the amount of trans-isomer present before the conversion reaction, which reaction occurs at a sufficient temperature to form the material that contains trans-isomer and cis-isomer.

The free-radical source is typically a peroxide, and preferably an organic peroxide, which decomposes during the cure cycle. Suitable free-radical sources include organic peroxide compounds, such as di-t-amyl peroxide, di(2-t-butyl-peroxyisopropyl)benzene peroxide or .alpha.,.alpha.-bis (t-butylperoxy)diisopropylbenzene, 11-bis(t-butylperoxy)-3,3,5-trimethy-lcyclohexane or 1,1-di(t-butylperoxy) 3,3,5-trimethyl cyclohexane, dicumyl peroxide, di-t-butyl peroxide, 2,5-di-(t-butylperoxy)-2,5-dimethyl hexane, n-butyl-4,4-bis(t-butylperoxy)valerate, lauryl peroxide, benzoyl peroxide, t-butyl hydroperoxide, and the like, and any mixture thereof.

The cis-to-trans catalyst may include an organosulfur compound, an inorganic sulfide, a Group VIA component, or a combination thereof. For instance, the cis-to-trans catalyst may be a halogenated organosulfur compound, such as pentafluorothiophenol; 2-fluorothiophenol; 3-fluorothiophenol; 4-fluorothiophenol; 2,3-fluorothiophenol; 2,4-fluorothiophenol; 3,4-fluorothiophenol; 3,5-fluorothiophenol 2,3,4-fluorothiophenol; 3,4,5-fluorothiophenol; 2,3,4,5-tetrafluorothiophenol; 2,3,5,6-tetrafluorothiophenol; 4-chlorotetrafluorothiophenol; pentachlorothiophenol; 2-chlorothiophenol; 3-chlorothiophenol; 4-chlorothiophenol; 2,3-chlorothiophenol; 2,4-chlorothiophenol; 3,4-chlorothiophenol; 3,5-chlorothiophenol; 2,3,4-chlorothiophenol; 3,4,5-chlorothiophenol; 2,3,4,5-tetrachlorothiophenol; 2,3,5,6-tetrachlorothiophenol; pentabromothiophenol; 2-bromothiophenol; 3-bromothiophenol; 4-bromothiophenol; 2,3-bromothiophenol; 2,4-bromothiophenol; 3,4-bromothiophenol; 3,5-bromothiophenol; 2,3,4-bromothiophenol; 3,4,5-bromothiophenol; 2,3,4,5-tetrabromothiophenol; 2,3,5,6-tetrabromothiophenol; pentaiodothiophenol; 2-iodothiophenol; 3-iodothiophenol; 4-iodothiophenol; 2,3-iodothiophenol; 2,4-iodothiophenol; 3,4-iodothiophenol; 3,5-iodothiophenol; 2,3,4-iodothiophenol; 3,4,5-iodothiophenol; 2,3,4,5-tetraiodothiophenol; 2,3,5,6-tetraiodothiophenoland; and their zinc salts, the metal salts thereof, and mixtures thereof, but is preferably pentachlorothiophenol or the metal salt thereof. In one embodiment, the metal salt is zinc, calcium, potassium, magnesium, sodium, lithium, or mixtures thereof.

The core composition may also include a crosslinking agent to increase the hardness of the reaction product. Suitable crosslinking agents include one or more metallic salts of unsaturated fatty acids having 3 to 8 carbon atoms, such as acrylic or methacrylic acid, or monocarboxylic acids, such as zinc, calcium, or magnesium acrylate salts, and the like, and mixtures thereof. Examples include, but are not limited to, one or more metal salt diacrylates, dimethacrylates, and monomethacrylates, wherein the metal is magnesium, calcium, zinc, aluminum, sodium, lithium, or nickel. Preferred acrylates include zinc acrylate, zinc diacrylate, zinc methacrylate, zinc dimethacrylate, and mixtures thereof.

Additional materials may be included in the core layer compositions outlined above. For example, coloring agents, optical brighteners, crosslinking agents, whitening agents such as TiO₂ and ZnO, UV absorbers, hindered amine light stabilizers, defoaming agents, processing aids, surfactants, and other conventional additives may be added to the core layer compositions of the invention. In addition, antioxidants, stabilizers, softening agents, plasticizers, including internal and external plasticizers, impact modifiers, foaming agents, density-adjusting fillers, reinforcing materials, and compatibilizers may also be added to any of the core layer compositions. One of ordinary skill in the art should be aware of the requisite amount for each type of additive to realize the benefits of that particular additive.

The core may also include one or more wound layers (surrounding a fluid or solid center) including at least one tensioned elastomeric material wound about the center. In one embodiment, the tensioned elastomeric material includes natural or synthetic elastomers or blends thereof. The synthetic elastomer preferably includes LYCRA. In another embodiment, the tensioned elastomeric material may also be formed from conventional polyisoprene. In still another embodiment, a polyurea composition is used to form the tensioned elastomeric material. In another embodiment, solvent spun polyether urea is used to form the tensioned elastomeric material in an effort to achieve a smaller cross-sectional area with multiple strands. The tensioned elastomeric layer may also be a high tensile filament having a tensile modulus of about 1,000,000 psi or greater.

As used herein, “intermediate layer” includes any layer between the innermost layer of the golf ball and the outermost layer of the golf ball. Therefore, intermediate layers may also be referred to as outer core layers, inner cover layers, and the like. When the golf ball of the present invention includes an intermediate layer, this layer may include any materials known to those of ordinary skill in the art, including various thermoset and thermoplastic materials, as well as blends thereof. For example, the intermediate layers of the golf ball of the invention may be formed with the highly neutralized compositions of the invention. The intermediate layer may likewise be formed, at least in part, from one or more homopolymeric or copolymeric materials, such as vinyl resins, polyolefins, polyurethanes, polyureas, polyamides, acrylic resins, olefinic thermoplastic rubbers, block copolymers of styrene and butadiene, isoprene or ethylene-butylene rubber, copoly(ether-amide), polyphenylene oxide resins, thermoplastic polyesters, ethylene, propylene, 1-butene or 1-hexene based homopolymers or copolymers, and the like.

The intermediate layer may also be formed from highly neutralized polymers such as those disclosed U.S. Patent Application Publication Serial Nos. 2001/0018375 and 2001/0019971, which are incorporated herein in their entirety by express reference thereto; grafted and non-grafted metallocene catalyzed polyolefins and polyamides, polyamide/ionomer blends, and polyamide/nonionomer blends, among other polymers.

Additional materials may be included in the intermediate layer compositions outlined above. For example, catalysts, coloring agents, optical brighteners, crosslinking agents, whitening agents such as TiO₂ and ZnO, UV absorbers, hindered amine light stabilizers, defoaming agents, processing aids, surfactants, and other conventional additives may be added to the intermediate layer compositions of the invention. In addition, antioxidants, stabilizers, softening agents, plasticizers, including internal and external plasticizers, impact modifiers, foaming agents, density-adjusting fillers, reinforcing materials, and compatibilizers may also be added to any of the intermediate layer compositions. One of ordinary skill in the art should be aware of the requisite amount for each type of additive to realize the benefits of that particular additive.

The intermediate layer may also be formed of a binding material and an interstitial material distributed in the binding material, a moisture barrier layer, or any polyurethane, polyurea, and polybutadiene materials.

The cover provides the interface between the ball and a club. As used herein, the term “cover” means the outermost portion of a golf ball. A cover typically includes at least one layer and may contain indentations such as dimples and/or ridges. Paints and/or laminates are typically disposed about the cover to protect the golf ball during use thereof. The cover may include a plurality of layers, e.g., an inner cover layer disposed about a golf ball center and an outer cover layer formed thereon.

Cover layers may be formed of the highly neutralized polymer compositions of the invention, however, other cover materials known to those of skill in the art are also contemplated for use with the present invention. For example, the cover may be formed of polyurea, polyurethane, or mixtures thereof.

In addition, cover layers may also be formed of one or more homopolymeric or copolymeric materials, such as vinyl resins, polyolefins, conventional polyurethanes and polyureas, polyamides, acrylic resins and blends of these resins with poly vinyl chloride, elastomers, and the like, thermoplastic urethanes, olefinic thermoplastic rubbers, block copolymers of styrene and butadiene, polyphenylene oxide resins or blends of polyphenylene oxide with high impact polystyrene, thermoplastic polyesters, ethylene, propylene, 1-butene or 1-hexane based homopolymers or copolymers including functional monomers, methyl acrylate, methyl methacrylate homopolymers and copolymers, low acid ionomers, high acid ionomers, alloys, and mixtures thereof. The cover may also be at least partially formed from the polybutadiene reaction product discussed above with respect to the core. In another embodiment, the cover is formed from balata, trans-polyisoprene, or a mixture thereof.

Additional materials may be included in the cover layer compositions outlined above. For example, catalysts, coloring agents, optical brighteners, crosslinking agents, whitening agents such as TiO₂ and ZnO, UV absorbers, hindered amine light stabilizers, defoaming agents, processing aids, surfactants, and other conventional additives may be added to the cover layer compositions of the invention. In addition, antioxidants, stabilizers, softening agents, plasticizers, including internal and external plasticizers, impact modifiers, foaming agents, density-adjusting fillers, reinforcing materials, and compatibilizers may also be added to any of the cover layer compositions. Those of ordinary skill in the art should be aware of the requisite amount for each type of additive to realize the benefits of that particular additive.

In addition, while hardness gradients are typically used in a golf ball to achieve certain characteristics, the present invention also contemplates the compositions of the invention being used in a golf ball with multiple cover layers having essentially the same hardness, wherein at least one of the layers has been modified in some way to alter a property that affects the performance of the ball.

The golf balls of the invention may be formed using a variety of application techniques such as compression molding, flip molding, injection molding, retractable pin injection molding, reaction injection molding (RIM), liquid injection molding (LIM), casting, vacuum forming, powder coating, flow coating, spin coating, dipping, spraying, and the like. In addition, a chilled chamber, i.e., a cooling jacket, may be used to cool the compositions of the invention when casting, which also allows for a higher loading of catalyst into the system.

One skilled in the art would appreciate that the molding method used may be determined at least partially by the properties of the composition. For example, casting, RIM, or LIM may be preferred when the material is thermoset, whereas compression molding or injection molding may be preferred for thermoplastic compositions. Compression molding, however, may also be used for thermoset inner ball materials. For example, when cores are formed from a thermoset material, compression molding is a particularly suitable method of forming the core, whereas when the cores are formed of a thermoplastic material, the cores may be injection molded. In addition, the intermediate layer may also be formed from using any suitable method known to those of ordinary skill in the art. For example, an intermediate layer may be formed by blow molding and covered with a dimpled cover layer formed by injection molding, compression molding, casting, vacuum forming, powder coating, and the like.

In addition, when covers are formed of polyurea and/or polyurethane compositions, these materials may be applied over an inner ball using a variety of application techniques such as spraying, compression molding, dipping, spin coating, casting, or flow coating methods that are well known in the art. In one embodiment, a combination of casting and compression molding can be used to form a polyurethane or polyurea composition over an inner ball. However, the method of forming covers according to the invention is not limited to the use of these techniques; other methods known to those skilled in the art may also be employed.

Prior to forming the cover layer, the inner ball, i.e., the core and any intermediate layers disposed thereon, may be surface treated to increase the adhesion between the outer surface of the inner ball and the cover. Examples of such surface treatment may include mechanically or chemically abrading the outer surface of the subassembly. Additionally, the inner ball may be subjected to corona discharge, plasma treatment, and/or silane dipping prior to forming the cover around it. Other layers of the ball, e.g., the core, also may be surface treated.

The golf balls of the invention are prefereably designed with certain flight characteristics in mind. The use of various dimple patterns and profiles provides a relatively effective way to modify the aerodynamic characteristics of a golf ball. As such, the manner in which the dimples are arranged on the surface of the ball can be by any available method. For instance, the ball may have an icosahedron-based pattern or an octahedral-based dimple pattern. Alternatively, the dimple pattern can be arranged according to phyllotactic pattern.

Dimple patterns may also be based on Archimedean patterns including a truncated octahedron, a great rhombcuboctahedron, a truncated dodecahedron, and a great rhombicosidodecahedron, wherein the pattern has a non-linear parting line. The golf balls of the present invention may also be covered with non-circular shaped dimples, i.e., amorphous shaped dimples.

Dimple patterns that provide a high percentage of surface coverage are preferred, and are well known in the art. In one embodiment, the golf balls of the invention have a dimple coverage of the surface area of the cover of at least about 60 percent, preferably at least about 65 percent, and more preferably at least 70 percent or greater. Dimple patterns having even higher dimple coverage values may also be used with the present invention. Thus, the golf balls of the present invention may have a dimple coverage of at least about 75 percent or greater, about 80 percent or greater, or even about 85 percent or greater.

In addition, a tubular lattice pattern may also be used with golf balls of the present invention. The golf balls of the present invention may also have a plurality of pyramidal projections disposed on the intermediate layer of the ball. The plurality of pyramidal projections on the golf ball may cover between about 20 percent to about 80 of the surface of the intermediate layer.

In an alternative embodiment, the golf ball may have a non-planar parting line allowing for some of the plurality of pyramidal projections to be disposed about the equator. This embodiment allows for greater uniformity of the pyramidal projections.

The total number of dimples on the ball, or dimple count, may vary depending such factors as the sizes of the dimples and the pattern selected. In general, the total number of dimples on the ball preferably is between about 100 to about 1000 dimples, although one skilled in the art would recognize that differing dimple counts within this range can significantly alter the flight performance of the ball. In one embodiment, the dimple count is about 380 dimples or greater, but more preferably is about 400 dimples or greater, and even more preferably is about 420 dimples or greater. In one embodiment, the dimple count on the ball is about 422 dimples. In some cases, it may be desirable to have fewer dimples on the ball. Thus, one embodiment of the present invention has a dimple count of about 380 dimples or less, and more preferably is about 350 dimples or less.

Dimple profiles revolving a catenary curve about its symmetrical axis may increase aerodynamic efficiency, provide a convenient way to alter the dimples to adjust ball performance without changing the dimple pattern, and result in uniformly increased flight distance for golfers of all swing speeds.

The golf balls of the present invention may be painted, coated, or surface treated for further benefits. For example, a golf ball of the invention may be treated with a base resin paint composition or the cover composition may contain certain additives to achieve a desired color characteristic. In one embodiment, the golf ball cover composition contains a fluorescent whitening agent, e.g. 2,2′-(2,5-thiophenediyl)bis(5-tert-butylbenzoxazole), to provide improved weather resistance and brightness.

Protective and decorative coating materials, as well as methods of applying such materials to the surface of a golf ball cover are well known in the golf ball art. Generally, such coating materials comprise urethanes, urethane hybrids, epoxies, polyesters and acrylics. If desired, more than one coating layer can be used. The coating layer(s) may be applied by any suitable method known to those of ordinary skill in the art. For example, the coating layer(s) may be applied to the golf ball cover by an in-mold coating process. In addition, the golf balls of the invention may be painted or coated with an ultraviolet curable/treatable ink.

In addition, trademarks or other indicia may be stamped, i.e., pad-printed, on the outer surface of the ball cover, and the stamped outer surface is then treated with at least one clear coat to give the ball a glossy finish and protect the indicia stamped on the cover.

The golf balls of the invention may also be subjected to dye sublimation, wherein at least one golf ball component is subjected to at least one sublimating ink that migrates at a depth into the outer surface and forms an indicia. The at least one sublimating ink preferably includes at least one of an azo dye, a nitroarylamine dye, or an anthraquinone dye.

Laser marking of a selected surface portion of a golf ball causing the laser light-irradiated portion to change color is also contemplated for use with the present invention. In addition, the golf balls may be subjected to ablation, i.e., directing a beam of laser radiation onto a portion of the cover, irradiating the cover portion, wherein the irradiated cover portion is ablated to form a detectable mark, wherein no significant discoloration of the cover portion results therefrom.

The properties such as hardness, modulus, core diameter, intermediate layer thickness and cover layer thickness of the golf balls of the present invention have been found to effect play characteristics such as spin, initial velocity and feel of the present golf balls. For example, the flexural and/or tensile modulus of the intermediate layer are believed to have an effect on the “feel” of the golf balls of the present invention. It should be understood that the ranges herein are meant to be intermixed with each other, i.e., the low end of one range may be combined with a high end of another range.

Dimensions of golf ball components, i.e., thickness and diameter, may vary depending on the desired properties. For the purposes of the invention, any layer thickness may be employed. Non-limiting examples of the various embodiments outlined above are provided here with respect to layer dimensions.

The present invention relates to golf balls of any size. While USGA specifications limit the size of a competition golf ball to more than 1.68 inches in diameter, golf balls of any size can be used for leisure golf play. The preferred diameter of the golf balls is from about 1.68 inches to about 1.8 inches. The more preferred diameter is from about 1.68 inches to about 1.76 inches. A diameter of from about 1.68 inches to about 1.74 inches is most preferred, however diameters anywhere in the range of from 1.7 to about 1.95 inches can be used. Preferably, the overall diameter of the core and all intermediate layers is about 80 percent to about 98 percent of the overall diameter of the finished ball.

The core may have a diameter ranging from about 0.09 inches to about 1.65 inches. In one embodiment, the diameter of the core of the present invention is about 1.2 inches to about 1.630 inches. In another embodiment, the diameter of the core is about 1.3 inches to about 1.6 inches, preferably from about 1.39 inches to about 1.6 inches, and more preferably from about 1.5 inches to about 1.6 inches. In yet another embodiment, the core has a diameter of about 1.55 inches to about 1.65 inches. For example, the core may have a diameter of about 1.585 inches.

The core of the golf ball may also be extremely large in relation to the rest of the ball. For example, in one embodiment, the core makes up about 90 percent to about 98 percent of the ball, preferably about 94 percent to about 96 percent of the ball. In this embodiment, the diameter of the core is preferably about 1.54 inches or greater, preferably about 1.55 inches or greater. In one embodiment, the core diameter is about 1.59 inches or greater. In another embodiment, the diameter of the core is about 1.64 inches or less.

When the core includes an inner core layer and an outer core layer, the inner core layer is preferably about 0.9 inches or greater and the outer core layer preferably has a thickness of about 0.1 inches or greater. In one embodiment, the inner core layer has a diameter from about 0.09 inches to about 1.2 inches and the outer core layer has a thickness from about 0.1 inches to about 0.8 inches. In yet another embodiment, the inner core layer diameter is from about 0.095 inches to about 1.1 inches and the outer core layer has a thickness of about 0.20 inches to about 0.03 inches.

The cover typically has a thickness to provide sufficient strength, good performance characteristics, and durability. In one embodiment, the cover thickness is from about 0.02 inches to about 0.35 inches. The cover preferably has a thickness of about 0.02 inches to about 0.12 inches, preferably about 0.1 inches or less. When the compositions of the invention are used to form the outer cover of a golf ball, the cover may have a thickness of about 0.1 inches or less, preferably about 0.07 inches or less. In one embodiment, the outer cover has a thickness from about 0.02 inches to about 0.07 inches. In another embodiment, the cover thickness is about 0.05 inches or less, preferably from about 0.02 inches to about 0.05 inches. In yet another embodiment, the outer cover layer of such a golf ball is between about 0.02 inches and about 0.045 inches. In still another embodiment, the outer cover layer is about 0.025 to about 0.04 inches thick. In one embodiment, the outer cover layer is about 0.03 inches thick.

In a golf ball having a relatively large core, e.g., about 1.55 inches to about 1.63 inches, the cover may have a thickness of about 0.02 inches to about 0.06 inches, preferably about 0.03 inches to about 0.05 inches. In one embodiment, the golf ball has a core with a diameter of about 1.56 inches to about 1.60 inches and a cover layer with a thickness of about 0.045 inches to about 0.050 inches. In another embodiment, the core has a diameter of about 1.58 inches to about 1.59 inches and a cover with a thickness of about 0.048 inches to about 0.050 inches. For example, a suitable golf ball construction according to the invention may include a core of about 1.585 inches and a cover having a thickness of about 0.049 inches. These dimensions are also suitable for a golf ball having dual core and dual cover layers, e.g., a center of soft polybutadiene, an outer core layer of a high performance polymer, an ionomer inner cover layer, and a soft urethane outer cover.

The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the invention, the intermediate layer, or inner cover layer, may have a thickness about 0.3 inches or less. In one embodiment, the thickness of the intermediate layer is from about 0.002 inches to about 0.1 inches, preferably about 0.01 inches or greater. In one embodiment, the thickness of the intermediate layer is about 0.09 inches or less, preferably about 0.06 inches or less. In another embodiment, the intermediate layer thickness is about 0.05 inches or less, more preferably about 0.01 inches to about 0.045 inches. In one embodiment, the intermediate layer, thickness is about 0.02 inches to about 0.04 inches. In another embodiment, the intermediate layer thickness is from about 0.025 inches to about 0.035 inches. In yet another embodiment, the thickness of the intermediate layer is about 0.035 inches thick. In still another embodiment, the inner cover layer is from about 0.03 inches to about 0.035 inches thick. Varying combinations of these ranges of thickness for the intermediate and outer cover layers may be used in combination with other embodiments described herein.

The ratio of the thickness of the intermediate layer to the outer cover layer is preferably about 10 or less, preferably from about 3 or less. In another embodiment, the ratio of the thickness of the intermediate layer to the outer cover layer is about 1 or less. The core and intermediate layer(s) together form an inner ball preferably having a diameter of about 1.48 inches or greater for a 1.68-inch ball. In one embodiment, the inner ball of a 1.68-inch ball has a diameter of about 1.52 inches or greater. In another embodiment, the inner ball of a 1.68-inch ball has a diameter of about 1.66 inches or less. In yet another embodiment, a 1.72-inch (or more) ball has an inner ball diameter of about 1.50 inches or greater. In still another embodiment, the diameter of the inner ball for a 1.72-inch ball is about 1.70 inches or less.

Most golf balls consist of layers having different hardnesses, e.g., hardness gradients, to achieve desired performance characteristics. The present invention contemplates golf balls having hardness gradients between layers, as well as those golf balls with layers having the same hardness.

It should be understood, especially to one of ordinary skill in the art, that there is a fundamental difference between “material hardness” and “hardness, as measured directly on a golf ball.” Material hardness is defined by the procedure set forth in ASTM-D2240 and generally involves measuring the hardness of a flat “slab” or “button” formed of the material of which the hardness is to be measured. Hardness, when measured directly on a golf ball (or other spherical surface) is a completely different measurement and, therefore, results in a different hardness value. This difference results from a number of factors including, but not limited to, ball construction (i.e., core type, number of core and/or cover layers, etc.), ball (or sphere) diameter, and the material composition of adjacent layers. It should also be understood that the two measurement techniques are not linearly related and, therefore, one hardness value cannot easily be correlated to the other.

The cores of the present invention may have varying hardnesses depending on the particular golf ball construction. In one embodiment, the core hardness is at least about 15 Shore A, preferably about 30 Shore A, as measured on a formed sphere. In another embodiment, the core has a hardness of about 50 Shore A to about 90 Shore D. In yet another embodiment, the hardness of the core is about 80 Shore D or less. Preferably, the core has a hardness about 30 to about 65 Shore D, and more preferably, the core has a hardness about 35 to about 60 Shore D.

The intermediate layer(s) of the present invention may also vary in hardness depending on the specific construction of the ball. In one embodiment, the hardness of the intermediate layer is about 30 Shore D or greater. In another embodiment, the hardness of the intermediate layer is about 90 Shore D or less, preferably about 80 Shore D or less, and more preferably about 70 Shore D or less. In yet another embodiment, the hardness of the intermediate layer is about 50 Shore D or greater, preferably about 55 Shore D or greater. In one embodiment, the intermediate layer hardness is from about 55 Shore D to about 65 Shore D. The intermediate layer may also be about 65 Shore D or greater.

When the intermediate layer is intended to be harder than the core layer, the ratio of the intermediate layer hardness to the core hardness preferably about 2 or less. In one embodiment, the ratio is about 1.8 or less. In yet another embodiment, the ratio is about 1.3 or less.

As with the core and intermediate layers, the cover hardness may vary depending on the construction and desired characteristics of the golf ball. The ratio of cover hardness to inner ball hardness is a primary variable used to control the aerodynamics of a ball and, in particular, the spin of a ball. In general, the harder the inner ball, the greater the driver spin and the softer the cover, the greater the driver spin.

For example, when the intermediate layer is intended to be the hardest point in the ball, e.g. about 50 Shore D to about 75 Shore D, the cover material may have a hardness of about 20 Shore D or greater, preferably about 25 Shore D or greater, and more preferably about 30 Shore D or greater, as measured on the slab. In another embodiment, the cover itself has a hardness of about 30 Shore D or greater. In particular, the cover may be from about 30 Shore D to about 70 Shore D. In one embodiment, the cover has a hardness of about 40 Shore D to about 65 Shore D, and in another embodiment, about 40 Shore D to about 55 Shore D. In another aspect of the invention, the cover has a hardness less than about 45 Shore D, preferably less than about 40 Shore D, and more preferably about 25 Shore D to about 40 Shore D. In one embodiment, the cover has a hardness from about 30 Shore D to about 40 Shore D.

In this embodiment when the outer cover layer is softer than the intermediate layer or inner cover layer, the ratio of the Shore D hardness of the outer cover material to the intermediate layer material is about 0.8 or less, preferably about 0.75 or less, and more preferably about 0.7 or less. In another embodiment, the ratio is about 0.5 or less, preferably about 0.45 or less.

In yet another embodiment, the ratio is about 0.1 or less when the cover and intermediate layer materials have hardnesses that are substantially the same. When the hardness differential between the cover layer and the intermediate layer is not intended to be as significant, the cover may have a hardness of about 55 Shore D to about 65 Shore D. In this embodiment, the ratio of the Shore D hardness of the outer cover to the intermediate layer is about 1.0 or less, preferably about 0.9 or less.

The cover hardness may also be defined in terms of Shore C. For example, the cover may have a hardness of about 70 Shore C or greater, preferably about 80 Shore C or greater. In another embodiment, the cover has a hardness of about 95 Shore C or less, preferably about 90 Shore C or less.

In another embodiment, the cover layer is harder than the intermediate layer. In this design, the ratio of Shore D hardness of the cover layer to the intermediate layer is about 1.33 or less, preferably from about 1.14 or less.

When a two-piece ball is constructed, the core may be softer than the outer cover. For example, the core hardness may range from about 30 Shore D to about 50 Shore D, and the cover hardness may be from about 50 Shore D to about 80 Shore D. In this type of construction, the ratio between the cover hardness and the core hardness is preferably about 1.75 or less. In another embodiment, the ratio is about 1.55 or less. Depending on the materials, for example, if a composition of the invention is acid-functionalized wherein the acid groups are at least partially neutralized, the hardness ratio of the cover to core is preferably about 1.25 or less.

Compression values are dependent on the diameter of the component being measured. Atti compression is typically used to measure the compression of a golf ball. As used herein, the terms “Atti compression” or “compression” are defined as the deflection of an object or material relative to the deflection of a calibrated spring, as measured with an Atti Compression Gauge, that is commercially available from Atti Engineering Corp. of Union City, N.J.

The Atti compression of the core, or portion of the core, of golf balls prepared according to the invention is preferably less than about 80, more preferably less than about 75. In another embodiment, the core compression is from about 40 to about 80, preferably from about 50 to about 70. For example, the core compression may be about 40 to about 50. In yet another embodiment, the core compression is preferably below about 50, and more preferably below about 25. In an alternative, low compression embodiment, the core has a compression less than about 20, more preferably less than about 10, and most preferably, 0. As known to those of ordinary skill in the art, however, the cores generated according to the present invention may be below the measurement of the Atti Compression Gauge.

In one embodiment, golf balls of the invention preferably have an Atti compression of about 55 or greater, preferably from about 60 to about 120. In another embodiment, the Atti compression of the golf balls of the invention is at least about 40, preferably from about 50 to 120, and more preferably from about 60 to 100. In yet another embodiment, the compression of the golf balls of the invention is about 75 or greater and about 95 or less. For example, a preferred golf ball of the invention may have a compression from about 80 to about 95, preferably about 80 to about 90. In one embodiment, the compression of a golf ball of the invention is about 87.

There is currently no USGA limit on the coefficient of restitution (COR) of a golf ball, but current U.S.G.A. rules state that the initial velocity of the golf ball cannot exceed 250±5 feet/second (ft/s) under U.S.G.A. established testing conditions. It is preferred that golf balls of the invention satisfy initial velocity requirements of the U.S.G.A. Thus, in one embodiment, the initial velocity is about 245 ft/s or greater and about 255 ft/s or less. In another embodiment, the initial velocity is about 250 ft/s or greater, but still complies with the U.S.G.A. initial velocity requirements. In one embodiment, the initial velocity is about 253 ft/s to about 254 ft/s. In yet another embodiment, the initial velocity is about 255 ft/s. While the current rules on initial velocity require that golf ball manufacturers stay within the limits stated above, one of ordinary skill in the art would appreciate that golf balls of the invention may be designed with initial velocities outside of this range. For example, a golf ball of the invention may be designed to have an initial velocity of about 220 ft/s or greater, preferably about 225 ft/s or greater.

As a result, of the initial velocity limitation set forth by the USGA, it may be desirable to maximize COR without violating the 255 ft/s limit. The COR of a ball is measured by taking the ratio of the outbound or rebound velocity to the incoming or inbound velocity. In a one-piece solid golf ball, the COR will depend on a variety of characteristics of the ball, including its composition and hardness. For a given composition, COR will generally increase as hardness is increased. In some two-piece solid golf balls, e.g., those having a core and a cover, the cover may be designed to produce a gain in COR over that of the core. When the contribution of the core to COR is substantial, a lesser contribution is required from the cover. Moreover, core compositions having a high COR may have covers around them that slow the ball or deaden its response to club impact. Similarly, when the cover contributes substantially to high COR of the ball, a lesser contribution is needed from the core.

The present invention contemplates golf balls having CORs from about 0.700 to about 0.850 at an inbound velocity of about 125 ft/sec. In one embodiment, the COR is about 0.750 or greater, preferably about 0.780 or greater. In another embodiment, the ball has a COR of about 0.800 or greater. In yet another embodiment, the COR of the balls of the invention is about 0.800 to about 0.815.

In addition, the inner ball preferably has a COR of about 0.780 or more. In one embodiment, the COR is about 0.790 or greater.

As known to those of ordinary skill in the art, the spin rate of a golf ball will vary depending on the golf ball construction. In a multilayer ball, e.g., a core, an intermediate layer, and a cover, wherein the cover is formed from the compositions of the invention, the spin rate of the ball off a driver (“driver spin rate”) may be about 2700 rpm or greater. In one embodiment, the driver spin rate is about 2800 rpm to about 3500 rpm. In another embodiment, the driver spin rate is about 2900 rpm to about 3400 rpm. In still another embodiment, the driver spin rate may be less than about 2700 rpm.

Two-piece balls made according to the invention may also have driver spin rates of 2700 rpm and greater. In one embodiment, the driver spin rate is about 2700 rpm to about 3300 rpm. Wound balls made according to the invention preferably have similar spin rates.

Methods of determining the spin rate should be well understood by those of ordinary skill in the art. Examples of methods for determining the spin rate are disclosed in U.S. Pat. Nos. 6,500,073, 6,488,591, 6,286,364, and 6,241,622, which are incorporated by reference herein in their entirety.

Accordingly, it is preferable that the golf balls of the present invention have an intermediate layer with a flexural modulus, as measured by ASTM D6272-02, of about 500 psi to about 500,000 psi. More preferably, the flexural modulus of the intermediate layer is about 1,000 psi to about 250,000 psi. Most preferably, the flexural modulus of the intermediate layer is about 2,000 psi to about 200,000 psi.

The flexural modulus of the cover layer is preferably about 2,000 psi or greater, and more preferably about 5,000 psi or greater. In one embodiment, the flexural modulus of the cover is from about 10,000 psi to about 150,000 psi. More preferably, the flexural modulus of the cover layer is about 15,000 psi to about 120,000 psi. Most preferably, the flexural modulus of the cover layer is about 18,000 psi to about 110,000 psi. In another embodiment, the flexural modulus of the cover layer is about 100,000 psi or less, preferably about 80,000 or less, and more preferably about 70,000 psi or less. For example, the flexural modulus of the cover layer may be from about 10,000 psi to about 70,000 psi, from about 12,000 psi to about 60,000 psi, or from about 14,000 psi to about 50,000 psi.

In one embodiment, when the cover layer has a hardness of about 50 Shore D to about 60 Shore D, the cover layer preferably has a flexural modulus of about 55,000 psi to about 65,000 psi.

In one embodiment, the ratio of the flexural modulus of the intermediate layer to the cover layer is about 0.003 to about 50. In another embodiment, the ratio of the flexural modulus of the intermediate layer to the cover layer is about 0.006 to about 4.5. In yet another embodiment, the ratio of the flexural modulus of the intermediate layer to the cover layer is about 0.11 to about 4.5.

In one embodiment, the compositions of the invention are used in a golf ball with multiple cover layers having essentially the same hardness, but differences in flexural moduli. In this aspect of the invention, the difference between the flexural moduli of the two cover layers is preferably about 5,000 psi or less. In another embodiment, the difference in flexural moduli is about 500 psi or greater. In yet another embodiment, the difference in the flexural moduli between the two cover layers, wherein at least one is reinforced is about 500 psi to about 10,000 psi, preferably from about 500 psi to about 5,000 psi. In one embodiment, the difference in flexural moduli between the two cover layers formed of unreinforced or unmodified materials is about 1,000 psi to about 2,500 psi.

The specific gravity, as measured by ASTM D297, of a cover or intermediate layer is preferably at least about 0.7. In one embodiment, the specific gravity of the intermediate layer or cover is about 0.8 or greater, preferably about 0.9 or greater. For example, in one embodiment, the golf ball has an intermediate layer with a specific gravity of about 0.9 or greater and a cover having a specific gravity of about 0.95 or greater. In another embodiment, the intermediate layer or cover has a specific gravity of about 1.00 or greater. In yet another embodiment, the specific gravity of the intermediate layer or cover is about 1.05 or greater, preferably about 1.10 or greater.

The core may have a specific gravity of about 1.00 or greater, preferably 1.05 or greater. For example, a golf ball of the invention may have a core with a specific gravity of about 1.10 or greater and a cover with a specific gravity of about 0.95 or greater.

The density of a core is preferably about 0.6 g/cm³ to about 10 g/cm³. In one embodiment, the density of the core is about 0.9 g/cm³ to about 8 g/cm³. In another embodiment, the core density is about 2 g/cm3 to about 6 g/cm³. If present, the outer core preferably has a density of about 0.6 g/cm³ to about 5 g/cm³, more preferably about 0.9 g/cm³ to about 3 g/cm³. Likewise, the density of the inner cover cover layer is preferably about 0.6 g/cm³ to about 5 g/cm³, more preferably about 0.9 g/cm³ to about 3 g/cm³. The outer cover layer of a golf ball of the invention preferably has a density of about 0.9 g/cm³ to about 1.55 g/cm³, more preferably about 0.95 g/cm³ to about 1.2 g/cm³.

With respect to layer to layer adhesion, the adhesions strength (or peel strength) of the compositions of the invention is preferably about 5 lb_{f}/in or greater. In one embodiment, the adhesion strength is about 25 lb_{f}/in or less. For example, the adhesion strength is preferably about 10 lb_{f}/in or more and about 20 lb_{f}/in or less. In another embodiment, the adhesion strength is about 20 lb_{f}/in or greater, preferably about 24 lb_{f}/in or greater. In yet another embodiment, the adhesion strength is about 26 lb_{f}/in or greater. In still another embodiment, the adhesion strength is about 20 lb_{f}/in to about 30 lb_{f}/in.

Skilled artisans are aware of methods to determine adhesion strength. For example, when testing adhesion strength of paint, cross-hatch tests and repeated ball impact tests are useful to determine the adhesion strength of a particular layer of a golf ball. The cross-hatch test consists of cutting the material into small pieces in mutually perpendicular directions, applying a piece of adhesive cellophane tape over the material, rapidly pulling off the tape, and counting the number of pieces removed. The repeated impact test consists of subjecting the finished golf ball to impact repeatedly and visually examining the coating film for peeling from the golf ball. The peel strength is measured using, a MTS Sintech® 30/G)or MTS Sintech® 5/G) mechanical test equipment to pull a 0.5-inch-wide section of a golf ball layer apart from the layer/core it is adheared to. The MTS includes a load cell of 100 N and a crosshead speed of 1.0 in/min. The golf ball is rotatedly secured in a manner such that a free rotation remains about a single axis perpendicular to the pull direction. Golf ball movement in other axes is not permitted.

Other than in the operating examples discussed below, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The following non-limiting examples are merely illustrative of the preferred embodiments of the present invention, and are not to be construed as limiting the invention, the scope of which is defined by the appended claims. Parts are by weight unless otherwise indicated.

### EXAMPLE 1

### Fully Neutralized Ammonium-Based Ionomer

A fully neutralized ammonium-based ionomer composition was made according to the invention with the formulation provided in Table 1:

TABLE 1
COMPOSITION AND PROPERTIES

| | | BASE RESIN | INVENTION |
|---|---|---|---|
| Nucrel ® 2940¹ | | 10 g | 10 g |
| Tetramethylammonium hydroxide | | — | 2 g |
| FTIR | Acid Intensity | 0.8 | 0.0 |
| (Absorbance²) | Carboxylate Intensity | 0.0 | 0.75 |
| Thermal - | Tₘ (° C.) | 82 | 83 |
| DSC | T_{c} (° C.) | 54 | 47 |

| | | |
|---|---|---|
| Stable (<130° C.) | Yes | Yes |
| MFI (@132.5° C., 2.16 kg) | 25 g/10 min. | 2.3 |

¹copolymer of ethylene and 19 percent methacrylic acid (available from DuPont) dissolved in 100 ml of xylene
²intensity relative to CH absorbance at about 2850 cm⁻¹.

As shown above in Table 1, the formulation of the invention, which was fully neutralized as shown by the acid intensity value of 0.0, was stable, and flowed well at temperatures below 130° C. This would not be true of a metal fully neutralized polymer, and has only been achieved in the prior art through the addition of metal salts of fatty acids, which are known to discolor the polymer and potentially bloom or delaminate.

### EXAMPLE 2

Melt Flow and Degree of Neutralization for Neutralized Compositions

As shown below in Table 2, compositions of the invention neutralized with an ammonium-based component had the following properties:

TABLE 2
PROPERTIES OF NEUTRALIZED COMPOSITIONS

| | Neutralized with | Commercially available | |
|---|---|---|---|
| | Ammonium-Based | Highly Neutralized | Commercially available |
| | Component of the | Polymers with Organic | Material without Organic |
| | Invention | Fatty Acids and their salts | Fatty Acid and their salts |
| Melt Flow (g/10 min) | 2.3 | 0.65 | 0.9 |
| Degree of | 100 | 100 | 55 |
| Neutralization (%) | | | |
| Flexural Modulus (ksi) | 30-45* | 31 | 54 |

*estimated value

### EXAMPLE 3

### Two-Piece Ball

Two-piece golf balls that could be made according to the invention may have properties as set forth in Table 3 wherein the cover layer is formed of the invention.

TABLE 3

| | Prophetic Example | Comparative Example |
|---|---|---|
| | using an Ammonium | Using Surlyn ® |
| | Neutralized Polymer | 6910 as a cover |
| | as a cover layer | layer |
| Core Properties: | | |
| Diameter (inches) | 1.590 | 1.590 |
| Compression | 70 | 70 |
| Outer surface Hardness | 45 | 45 |
| (Shore D) | | |
| CoR at 125 ft/sec | 0.810 | 0.810 |
| Cover Material | | |
| Properties | | |
| Flexural Modulus (kpsi) | 40 | 54 |
| Hardness (Shore D) | 51 | 63 |
| Ball Properties | | |
| Compression | 82 | 90 |
| CoR at 125 ft/sec | 0.820 | 0.815 |

### EXAMPLE 4

### Multi-layer Golf Balls Made According to the Invention

Multilayer golf balls that could be made according to the invention may have properties as set forth in Tables 4 and 5. Table 4 shows a three-piece ball an inner cover layer formed of the neutralized compositions of the invention whereas the Table 5 shows an example of a four-piece ball having outer core layers formed of the neutralized compositions of the invention.

TABLE 4
THREE-PIECE BALL (CORE, INTERMEDIATE LAYER, AND COVER)

| | Prophetic Example | Comparative Example |
|---|---|---|
| | using a present invention of | Using a conventional |
| | Ammonium Neutralized | Ionomer Surlyn ® 6910 |
| | Polymer as an inner cover layer | as an innner cover layer |
| Core Composition & Properties: | Thermoset BR | Thermoset BR |
| Diameter (inches) | 1.38 | 1.38 |
| Compression | 60 | 60 |
| CoR at 125 ft/sec | 0.794 | 0.794 |
| Specific gravity | 1.116 | 1.116 |
| Outer surface Hardness (Shore C) | 81 | 81 |
| Inner Cover layer Properties | | |
| Thickenss (inches) | 0.096 | 0.096 |
| Compression | 83 | 92 |
| CoR at 125 ft/sec | 0.806 | 0.798 |
| Surface Hardness (Shore D) | 55 | 62 |
| Outer Cover Composition | Butadiene/Balata blend (cured | Butadiene/Balata blend (cured |
| | with ZDA) | with ZDA) |
| Ball Properties | | |
| Hardness (Shore D) | 52 | 58 |
| Compression | 86 | 95 |
| CoR at 125 ft/sec | 0.804 | 0.796 |

TABLE 5
FOUR-PIECE BALL (INNER CORE, OUTER CORE, INNER COVER, OUTER COVER)

| | Prophetic Example | Comparative Example |
|---|---|---|
| | using a present invention of | Using a |
| | Ammonium Neutralized Polymer | Surlyn ® HPF 2000 Ionomer |
| | as an outer core layer | as an outer core layer |
| Center Composition & Properties: | Thermoset BR | Thermoset BR |
| Diameter (inches) | 1.131 | 1.131 |
| Compression | 55 | 55 |
| CoR at 125 ft/sec | 0.787 | 0.787 |
| Specific gravity | 1.126 | 1.126 |
| Outer surface Hardness (Shore C) | 84 | 84 |
| Outer Core layer Properties | | |
| Thickenss (inches) | 0.133 | 0.133 |
| Compression | 72 | 77 |
| CoR at 125 ft/sec | 0.815 | 0.809 |
| Surface Hardness (Shore D) | 51 | 54 |
| Inner Cover Composition and Properties | Ionomer (Na/Mg/Zn ionomer) | Ionomer (Na/Mg/Zn ionomer) |
| Thickenss (inches) | 0.032 | 0.032 |
| Compression | 83 | 88 |
| CoR at 125 ft/sec | 0.825 | 0.819 |
| Surface Hardness (Shore D) | 65 | 65 |
| Outer Cover Composition | Butadiene/Balata blend (cured with | Butadiene/Balata blend (cured |
| | ZDA) | with ZDA) |
| Ball Properties | | |
| Hardness (Shore D) | 55 | 55 |
| Compression | 94 | 99 |
| CoR at 125 ft/sec | 0.823 | 0.816 |

While it is apparent that the invention explicitly disclosed herein can be used to form neutralized compositions not previously known to those of skill in the art, it will be appreciated that numerous modifications and embodiments may be devised by those skilled in the art. For example, while golf balls and golf ball components are used as examples for articles incorporating the compositions of the invention, other golf equipment may be formed from the compositions of the invention. In one embodiment, at least a portion of a golf shoe is formed from the composition of the invention. In another embodiment, the composition of the invention is used to form at least a portion of a golf club, e.g., a putter insert. Therefore, it is intended that the appended claims cover all such modifications and embodiments that fall within the true spirit and scope of the present invention.

What is claimed is:

1. A golf ball comprising at least one layer formed of a reaction product comprising:
a thermoplastic resin component having a first amount of neutralized acid groups; and
a plasticizing agent selected from the group consisting of an inner salt, a chelate, a surfactant, a phospholipid, an ionic liquid, a long-chain organic carbonate, a main-chain heteroatom-substituted fatty acid, and mixtures thereof, wherein the reaction product has a second amount of neutralized acid groups greater than the first, and wherein the second amount is 70% or greater.

2. The golf ball of claim 1, wherein the thermoplastic resin component is a copolymer of ethylene and acrylic acid or methacrylic acid.

3. The golf ball of claim 1, wherein the second amount is 80% or greater.

4. The golf ball of claim 1, wherein the second amount is 90% or greater.

5. The golf ball of claim 1, further comprising a neutralizing agent selected from the group consisting of ammonium-based components, salts of ammonium-based components, amine-based components, salts of amine-based components, and mixtures thereof.

6. A golf ball comprising:
a core,
a cover; and
an intermediate layer disposed between the core and the cover, wherein the intermediate layer comprises:
a thermoplastic resin component comprising acid groups; and
a neutralizing agent selected from the group consisting of an inner salt, a chelate, a surfactant, a phospholipid, an ionic liquid, a long-chain organic carbonate, a main-chain heteroatom-substituted fatty acid, and mixtures thereof,
wherein the acid groups are at least about 70% neutralized.

7. The golf ball of claim 6, wherein the acid groups are 100% neutralized.

8. The golf ball of claim 6, wherein the intermediate layer has a hardness of about 30 Shore D to about 70 Shore D.

9. The golf ball of claim 6, wherein the cover comprises a castable polyurethane, a polyurea, or a mixture thereof.

10. The golf ball of claim 6, wherein about 80% or greater of the acid groups are neutralized by the neutralizing agent.

11. The golf ball of claim 10, wherein about 90% or greater of the acid groups are neutralized by the neutralizing agent.

12. The golf ball of claim 6, wherein the thermoplastic resin component is a copolymer of ethylene and acrylic acid or methacrylic acid.

13. A golf ball comprising at least one layer formed of a reaction product comprising:
a thermoplastic resin component comprising acid groups, wherein the thermoplastic resin component is a copolymer of ethylene and acrylic acid or methacrylic acid; and
a plasticizing agent selected from the group consisting of an inner salt, a chelate, a surfactant, a phospholipid, an ionic liquid, a long-chain organic carbonate, a main-chain heteroatom-substituted fatty acid, and mixtures thereof,
wherein the acid groups are at least 70% neutralized.

14. The golf ball of claim 13, wherein less than 70% of the acid groups are neutralized with a metal cation and the balance being neutralized by the plasticizing agent.

15. The golf ball of claim 13, wherein 30% or greater of the neutralized acid groups are neutralized by the plasticizing agent.

16. The golf ball of claim 15, wherein 50% or greater of the neutralized acid groups are neutralized by the plasticizing agent.

17. The golf ball of claim 16, wherein 80% or greater of the neutralized acid groups are neutralized by a neutralizing agent.
